(19) United States
(12) Patent Application Publication
(10) Pub. No.: US 2004/0254977 A1
(43) Pub. Date: Dec. 16, 2004

(54) Extensible peer-to-peer graphing messages

(75) Inventor: Xiaohai Zhang, Kenmore, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/460,943

(22) Filed: Jun. 13, 2003

(51) Int. Cl. G06F 15/16; G06F 7/00; G06F 17/30

(52) U.S. Cl. 709/201; 709/230; 707/10

(57) ABSTRACT

An embodiment of the present invention provides for extensible peer-to-peer graphing messages that address the shortcomings of conventional serverless group creation and maintenance mechanisms. Extensible peer-to-peer graphing message formats are described. A connecting mode of peer-to-peer graphing communications includes peer-to-peer graphing authentication information, connect, refuse, welcome and disconnect messages. A synchronizing mode includes peer-to-peer graphing solicit new, solicit time, solicit hash, advertise, request and synchronize end messages. A flooding mode includes peer-to-peer graphing flood and acknowledge messages. A peer-to-peer graphing point-to-point message is also disclosed.

### FIELD OF THE INVENTION

This invention pertains generally to computer networks and, more particularly, to peer-to-peer computer networks.

### BACKGROUND OF THE INVENTION

Enabling group communication is a popular application of computer networks. Groups of people use computer networks to share every kind of digital data from simple text and static images to encoded audio and video and more specialized data that enables real-time collaboration and multi-player games. It is desirable, particularly in large computer networks, for a subset of computer network users to be able to form ad hoc communication groups more or less at will, and, perhaps just as desirably, particularly in public computer networks, to be able to exclude hostile or unauthorized computer network users from the group.

It has been common for group formation and communication to take place in server-centric environments where resource-rich central servers manage and route communications between group members, but the inherent constraints of server-centric environments can sometimes hinder group communications instead of aiding them and so there has arisen a demand for group formation mechanisms in a serverless or peer-to-peer computer networking environment. Conventional serverless group creation and maintenance mechanisms such as the Network News Transport Protocol (NNTP) and, in some respects, Open Shortest Path First (OSPF) routing, suffer from limitations that have, to date, prevented them from being used to implement the kind of flexible and secure communication groups that computer network users have come to expect.

### BRIEF SUMMARY OF THE INVENTION

This section presents a simplified summary of some embodiments of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An embodiment of the present invention provides for extensible peer-to-peer graphing messages that address the shortcomings of conventional serverless group creation and maintenance mechanisms. Extensible peer-to-peer graphing message formats in accordance with an embodiment of the invention are described herein.

In an embodiment of the invention, a connecting mode of peer-to-peer graphing communications includes peer-to-peer graphing authentication information, connect, refuse, welcome and disconnect messages. A synchronizing mode of peer-to-peer graphing communications in accordance with an embodiment of the invention includes peer-to-peer graphing solicit new, solicit time, solicit hash, advertise, request and synchronize end messages. A flooding mode of peer-to-peer graphing communications in accordance with an embodiment of the invention includes peer-to-peer graphing flood and acknowledge messages. A peer-to-peer graphing point-to-point message in accordance with an embodiment of the invention is herein disclosed.

### BRIEF DESCRIPTION OF THE DRAWINGS

While the appended claims set forth the features of the invention with particularity, the invention and its advantages are best understood from the following detailed description taken in conjunction with the accompanying drawings, of which:

FIG. 1 is a schematic diagram illustrating computers connected by a network;

FIG. 2 is a schematic diagram generally illustrating an exemplary computer system usable to implement an embodiment of the invention;

FIG. 3 is a schematic diagram depicting peers in an example peer-to-peer graph;

FIG. 4 is a schematic diagram illustrating a modular software architecture in accordance with an embodiment of the invention;

FIG. 5A is a schematic diagram illustrating an example general layout of a peer-to-peer graphing message in accordance with an embodiment of the invention;

FIG. 5B is a schematic diagram illustrating an exemplary general layout of a subsequent version peer-to-peer graphing message in accordance with an embodiment of the invention;

FIG. 6 is a computer-readable medium format diagram for an exemplary peer-to-peer graphing message header in accordance with an embodiment of the invention;

FIG. 7 is a computer-readable medium format diagram for an exemplary peer-to-peer graphing message frame in accordance with an embodiment of the invention;

FIG. 8 is a computer-readable medium format diagram for an exemplary peer-to-peer graphing authentication information message in accordance with an embodiment of the invention;

FIG. 9 is a protocol diagram depicting a connecting mode of peer-to-peer communications in accordance with an embodiment of the invention;

FIG. 10 is a computer-readable medium format diagram for an exemplary peer-to-peer graphing connect message in accordance with an embodiment of the invention;

FIG. 11 is a computer-readable medium format diagram for an exemplary peer-to-peer graphing refuse message in accordance with an embodiment of the invention;

FIG. 12 is a computer-readable medium format diagram for an exemplary peer-to-peer graphing welcome message in accordance with an embodiment of the invention;

FIG. 13 is a computer-readable medium format diagram for an exemplary peer-to-peer graphing disconnect message in accordance with an embodiment of the invention;

FIG. 14 is a protocol diagram depicting a synchronizing mode of peer-to-peer communications incorporating a solicit new message in accordance with an embodiment of the invention;

FIG. 15 is a computer-readable medium format diagram for an exemplary peer-to-peer graphing solicit new message in accordance with an embodiment of the invention;

FIG. 16 is a computer-readable medium format diagram for an exemplary peer-to-peer graphing synchronize end message in accordance with an embodiment of the invention;

FIG. 17 is a schematic diagram illustrating a peer-to-peer graph record set in accordance with an embodiment of the invention;

FIG. 18A is a protocol diagram depicting a synchronizing mode of peer-to-peer communications incorporating a solicit time message in accordance with an embodiment of the invention;

FIG. 18B is a protocol diagram depicting a synchronizing mode of peer-to-peer communications incorporating a solicit hash message in accordance with an embodiment of the invention;

FIG. 19 is a computer-readable medium format diagram for an exemplary peer-to-peer graphing solicit time message in accordance with an embodiment of the invention;

FIG. 20 is a computer-readable medium format diagram for an exemplary peer-to-peer graphing solicit hash message in accordance with an embodiment of the invention;

FIG. 21 is a computer-readable medium format diagram for an exemplary peer-to-peer graphing advertise message in accordance with an embodiment of the invention;

FIG. 22 is a computer-readable medium format diagram for an exemplary peer-to-peer graphing request message in accordance with an embodiment of the invention;

FIG. 23 is a computer-readable medium format diagram for an exemplary peer-to-peer graphing flood message in accordance with an embodiment of the invention;

FIG. 24 is a computer-readable medium format diagram for an exemplary peer-to-peer graphing acknowledge message in accordance with an embodiment of the invention; and

FIG. 25 is a computer-readable medium format diagram for an exemplary peer-to-peer graphing point-to-point message in accordance with an embodiment of the invention.

### DETAILED DESCRIPTION OF THE INVENTION

Prior to proceeding with a description of the various embodiments of the invention, a description of a computer and networking environment in which the various embodiments of the invention may be practiced is now provided. Although not required, the invention will be described in the general context of computer-executable instructions, such as program modules, being executed by a computer. Generally, programs include routines, objects, components, data structures and the like that perform particular tasks or implement particular abstract data types. The term“program” as used herein may connote a single program module or multiple program modules acting in concert. The terms“computer” and“computing device” as used herein include any device that electronically executes one or more programs, such as personal computers (PCs), hand-held devices, multi-processor systems, microprocessor-based programmable consumer electronics, network PCs, minicomputers, tablet PCs, laptop computers, consumer appliances having a microprocessor or microcontroller, routers, gateways, hubs and the like. The invention may also be employed in distributed computing environments, where tasks are performed by remote processing devices that are linked through a communications network. In a distributed computing environment, programs may be located in both local and remote memory storage devices.

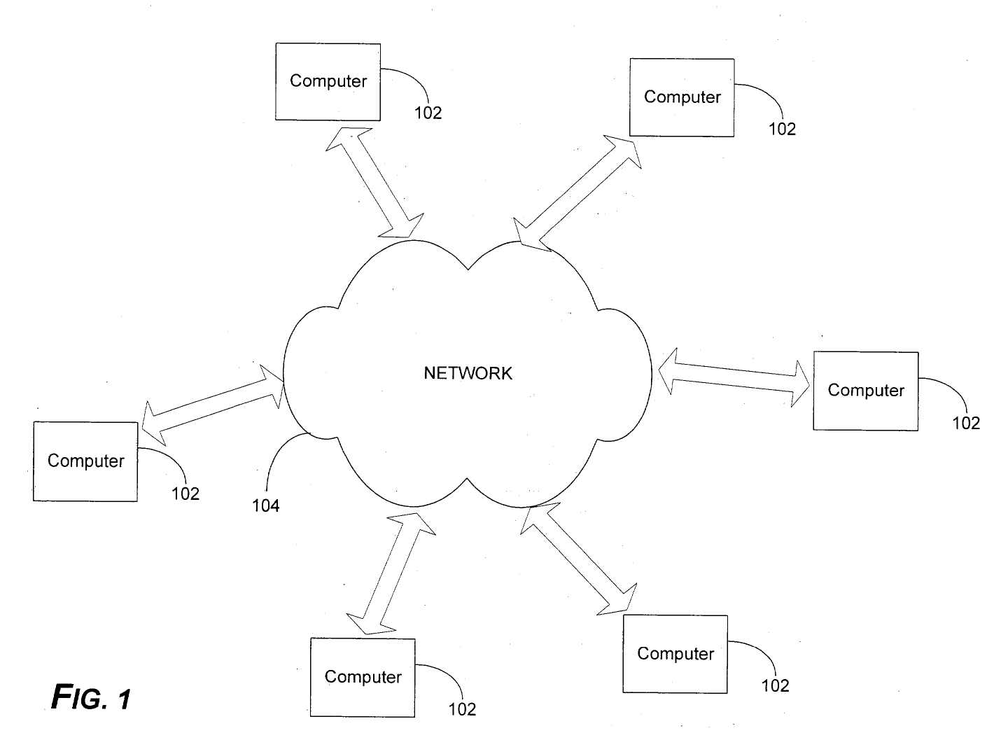

An example of a computer networking environment suitable for incorporating aspects of the invention is described with reference to FIG. 1. The example computer networking environment includes several computers 102 communicating with one another over a network 104, represented by a cloud. Network 104 may include many well-known components, such as routers, gateways, hubs, etc. and allows the computers 102 to communicate via wired and/or wireless media. When interacting with one another over the network 104, one or more of the computers 102 may act as clients, servers or peers with respect to other computers 102. Accordingly, the various embodiments of the invention may be practiced on clients, servers, peers or combinations thereof, even though specific examples contained herein may not refer to all of these types of computers.

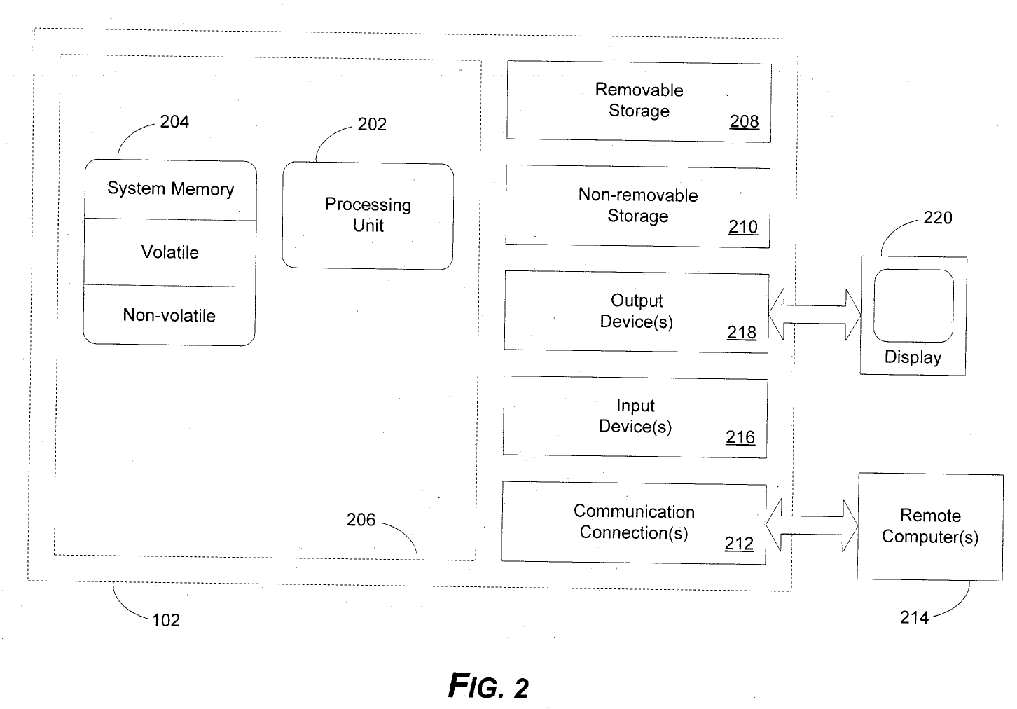

Referring to FIG. 2, an example of a basic configuration for the computer 102 on which aspects of the invention described herein may be implemented is shown. In its most basic configuration, the computer 102 typically includes at least one processing unit 202 and memory 204. The processing unit 202 executes instructions to carry out tasks in accordance with various embodiments of the invention. In carrying out such tasks, the processing unit 202 may transmit electronic signals to other parts of the computer 102 and to devices outside of the computer 102 to cause some result. Depending on the exact configuration and type of the computer 102, the memory 204 may be volatile (such as RAM), non-volatile (such as ROM or flash memory) or some combination of the two. This most basic configuration is illustrated in FIG. 1 by dashed line 206.

The computer 102 may also have additional features/functionality. For example, computer 102 may also include additional storage (removable 208 and/or non-removable 210) including, but not limited to, magnetic or optical disks or tape. Computer storage media includes volatile and non-volatile, removable and non-removable media implemented in any method or technology for storage of information, including computer-executable instructions, data structures, program modules, or other data. Computer storage media includes, but is not limited to, RAM, ROM, EEPROM, flash memory, CD-ROM, digital versatile disk (DVD) or other optical storage, magnetic cassettes, magnetic tape, magnetic disk storage or other magnetic storage devices, or any other medium which can be used to stored the desired information and which can be accessed by the computer 102. Any such computer storage media may be part of computer 102.

The computer 102 preferably also contains communications connections 212 that allow the device to communicate with other devices such as remote computers 214. A communication connection is an example of a communication medium. Communication media typically embody computer readable instructions, data structures, program modules or other data in a modulated data signal such as a carrier wave or other transport mechanism and includes any information delivery media. By way of example, and not limitation, the term “communication media” includes wireless media such as acoustic, RF, infrared and other wireless media. The term“computer-readable medium” as used herein includes both computer storage media and communication media.

The computer 102 may also have input devices 216 such as a keyboard/keypad, mouse, pen, voice input device, touch input device, etc. Output devices 218 such as a display 220, speakers, a printer, etc. may also be included. All these devices are well known in the art and need not be described at length here.

In the description that follows, the invention will be described with reference to acts and symbolic representations of operations that are performed by one or more computing devices, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

Additional details and context relevant to the present invention may be found in co-pending U.S. patent application Ser. No. 09/955923, entitled Peer-to-Peer Group Management and Method for Maintaining Peer-to-Peer Graphs, filed on Sep. 19, 2001.

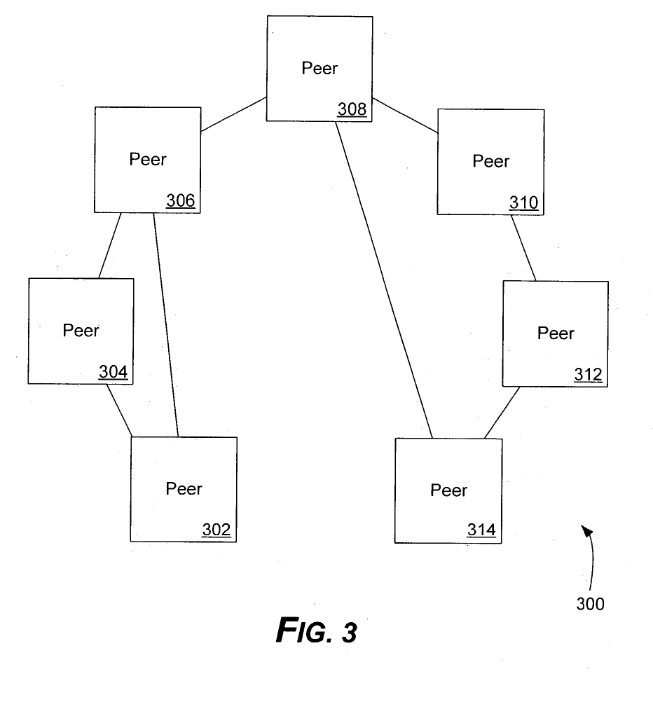

In an embodiment of the invention, joining a peer-to-peer (P2P) communications group includes joining a graph of connected peers (e.g., computer users). FIG. 3 illustrates an example peer-to-peer (P2P) graph suitable for incorporating aspects of the invention. Each peer 302, 304, 306, 308, 310, 312, 314 may communicate with any other peer 302, 304, 306, 308, 310, 312, 314 in the peer-to-peer graph 300 either directly or indirectly. For example, peer 302 may communicate with peer 306 directly, but in order to communicate with peer 314, data first propagates through peer 306 and then peer 308. Peer 308 may communicate with peer 314 directly, alternatively, peer 308 may communicate indirectly with peer 314 via peer 310 and then peer 312.

A single computer may enable more than one peer, for example, peer 302, peer 304 and peer 306 may interact with the computer network 104 from the same computer 102. A single peer may be enabled by more than one computer, for example, peer 312 may interact with the computer network 104 from a distributed computing environment including several computers 102. Peer-to-peer connections are independent of an underlying data transport mechanism, for example, the connection between peer 314 and peer 308 may be implemented utilizing Transmission Control Protocol (TCP) and Internet Protocol Version 4 (IPv4), the connection between peer 314 and peer 312 may be implemented utilizing TCP and Internet Protocol Version 6 (IPv6), and the connection between peer 302 and peer 304 may be ultimately implemented as a copy of one memory location to another within the same computer 102. While some of the examples described herein have particular relevance to TCP and IPv6, in an embodiment of the invention, the peer-to-peer graphing protocol and associated protocol messages may be layered on top of any suitable underlying data communications protocol. Each peer 302, 304, 306, 308, 310, 312, 314 may participate in more than one peer-to-peer graph (not shown in FIG. 3).

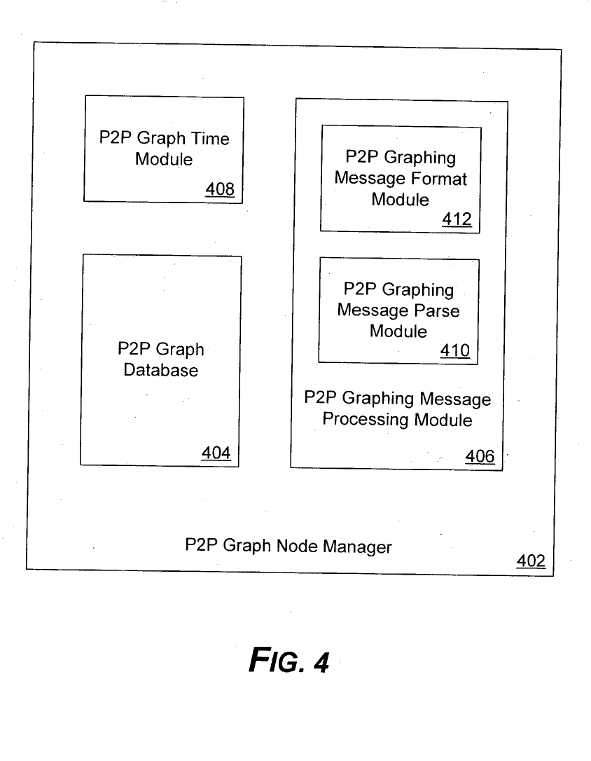

FIG. 4 illustrates an example modular software architecture in accordance with an embodiment of the invention. A peer-to-peer graph node manager 402 includes a peer-to-peer graph database 404, a peer-to-peer graphing message processing module 406, and a peer-to-peer graph time module 408. The peer-to-peer graphing message processing module 406 includes a peer-to-peer graphing message parse module 410 and a peer-to-peer graphing message format module 412. The peer-to-peer graph database 404 contains a set of records for each peer-to-peer graph (e.g., the peer-to-peer graph illustrated in FIG. 3) in which a peer utilizing the node manager 402 participates. The peer-to-peer graph time module 408 maintains a graph time for each peer-to-peer graph.

The peer-to-peer graphing message parse module 410 parses (e.g., disassembles) peer-to-peer graphing messages that are received from other nodes in the peer-to-peer graph, for example, the parse module 410 may extract one or more peer-to-peer graph database records encoded by another peer-to-peer graph node and insert the records into the peer-to-peer graph database 404. The peer-to-peer graphing message format module 412 formats (e.g., assembles) peer-to-peer graphing messages before the messages are sent to another peer-to-peer graph node, for example, the format module 412 may encode one or more peer-to-peer graph database 404 records into a peer-to-peer graphing message. In an embodiment of the invention, an attribute possessed by a peer or an action taken by a peer may be read as being possessed or taken by the peer's node manager unless the context clearly indicates otherwise.

In an embodiment of the invention, each peer (e.g., the peer 302 of FIG. 3) has a peer identifier (peer ID), for example, a text string, a public key for the peer or cryptographic hash thereof. Furthermore, each peer-to-peer graph (e.g., the graph 300 of FIG. 3) has a graph identifier (graph ID), for example, a Uniform Resource Locator (URL), a public authentication key for the graph, or a cryptographic hash of the public key. In addition, each peer has a peer-to-peer graph node identifier (node ID) for each graph in which the peer participates. For example, the node ID may be a 64 bit pseudo-randomly generated number. Other peer-to-peer graph node identifier generation schemes are possible, as will be apparent to one of skill in the art. In an embodiment of the invention, a peer-to-peer graph node is an interface of a peer to a particular graph.

In an embodiment of the invention, each peer-to-peer graph has a theoretical graph time associated with the graph. Time for the graph as a whole may differ from the time as measured at each peer in the peer-to-peer graph, for example, a clock at peer 302 (of FIG. 3) may differ by seconds or minutes from a clock at peer 314. Time for the graph as a whole (graph time) is first set by the original node of the peer-to-peer graph. Each peer in the peer-to-peer graph maintains a clock set to the graph time, for example, the peer-to-peer graph time module 408 of the peer's node manager (e.g., the node manager 402 of FIG. 4) may maintain a simple offset to a local clock for each graph in which the peer participates. More sophisticated graph time maintenance schemes are possible as will be appreciated by one of skill in the art. Graph time for a peer-to-peer graph is maintained relative to the clock of the original node even if the original node leaves the graph.

In an embodiment of the invention, each node in the peer-to-peer graph attempts to maintain a synchronized set of database 404 records associated with the graph, i.e., a peer-to-peer graph record set. When the peer-to-peer graph record set changes at one graph node, the node propagates the change to each of the other graph nodes. In an embodiment of the invention, peer-to-peer graphing messages described below are utilized to maintain the peer-to-peer graph record set at each node in the graph.

Each node in the peer-to-peer graph may be in one of four basic communication modes with respect to another node: not connected, connecting, synchronizing, and flooding. Each node may be in a different communications mode with respect to each other peer-to-peer graph node. Nodes do not exchange messages directly in the not connected mode. In the connecting mode, a first peer-to-peer graph node (e.g., peer 302 in graph 300 of FIG. 3) attempts to establish a direct connection to a second peer-to-peer graph node (e.g., peer 308). Once connected, the first node attempts to synchronize its peer-to-peer graph record set with the graph record set of the second node in the synchronizing mode. Once synchronized, the first node participates in the peer-to-peer graph in the flooding communications mode. Before describing each communications mode and its associated messages in more detail, some general principles of peer-to-peer graphing message design in accordance with an embodiment of the invention are described. In an embodiment of the invention, peer-to-peer graphing messages are messages that are, for example, formatted, sent, received and/or parsed by networked peers in order to create and/or maintain a peer-to-peer graph.

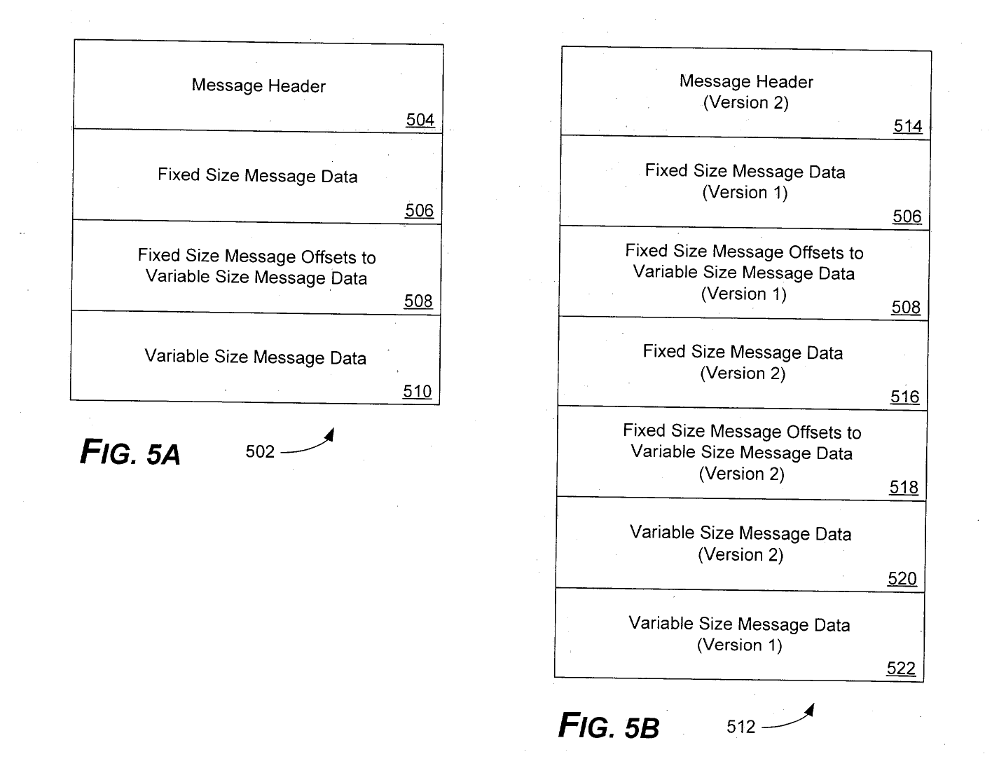

In an embodiment of the invention, each peer-to-peer graphing message has a plurality of parts in order to aid flexibility and extensibility. FIG. 5A illustrates an exemplary general layout of a peer-to-peer graphing message 502 in accordance with an embodiment of the invention. The peer-to-peer graphing message 502 includes a message header part 504 and a fixed size message data part 506. The message 502 optionally includes a fixed size message offset(s) to variable size message data part 508 and a variable size message data part 510. A peer-to-peer graphing message may vary from this general format for reasons, for example, of efficient packing of message data fields.

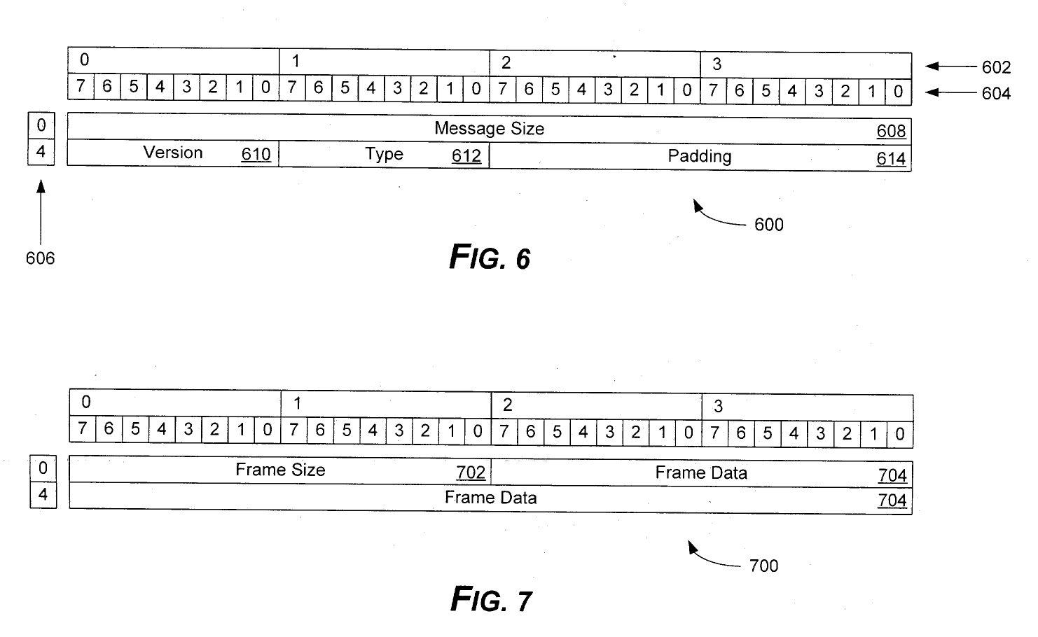

The message header part 504 is discussed in more detail below with reference to FIG. 6. The fixed size message data part 506 includes one or more fields of data, each of which always occupies the same number of bits. Some data fields may logically occupy a variable number of bits, for example, null-byte terminated text strings and variable length arrays. If the peer-to-peer graphing message 502 includes one or more variable length data fields, then, for each variable length data field, the message 502 will include a fixed size message offset, in this example a 2 byte value, that indicates, for example, counting the first byte in the message header part 504 as zero, the byte location of the start of the variable length data field in the variable size message data part 510 of the message 502.

FIG. 5B illustrates a general layout of an example subsequent version peer-to-peer graphing message 512 in accordance with an embodiment of the invention, that is, message 512 is of a subsequent peer-to-peer graphing message design with respect to message 502, for example, message 502 may correspond to a first version peer-to-peer graphing message design and message 512 may correspond to a second version peer-to-peer graphing message design. The subsequent version message 512 includes a version 2 message header part 514 as well as the fixed size message data part 506 and fixed size message offset(s) part 508 of version 1 of the peer-to-peer graphing message (i.e., the message 502 of FIG. 5A). The subsequent version message 512 further includes version 2 fixed size message data 516 and version 2 fixed size message offset(s) to variable size message data 518. The variable size message data part 520 includes variable size message data fields from version 2 of the peer-to-peer graphing message. The variable size message data part 522 includes variable size message data fields from version 1 of the peer-to-peer graph message. The formatting of the variable size message data parts 520, 522 is particularly flexible, so that it is possible, for example, to consider the variable size message data parts 520, 522 as a single message part.

An advantage of the arrangement is that subsequent message versions are byte compatible with regard to the fixed size parts of the earlier message versions so that, for example, later version peer-to-peer graphing message parsing modules (e.g., the message parse module 410 of FIG. 4) may be able to employ earlier version parsing instructions unchanged. Another advantage is that an earlier version parser receiving a later version message may successfully parse the later version message by ignoring later version fixed size data fields (e.g., message part 516 and message part 518).

FIG. 6 depicts an exemplary peer-to-peer graphing message header 600 in accordance with an embodiment of the invention. In an embodiment of the invention, each peer-to-peer peer graphing message includes a message header exemplified by the message header 600. As with like figures, for example, FIGS. 7, 8, 10-13, 15, 16 and 19-25, the message header 600 is depicted in rows of at least four bytes. A byte label 602 marks the boundaries of each byte in the row. A bit label 604 marks the boundaries of each bit in the row and shows the order of bits in a byte: ‘7’ labels the most significant bit, ‘0’ labels the least significant bit. A row label 606 shows the offset of the first byte of each row from the start of the message. FIG. 6 and like figures show a strictly defined data field size and order in accordance with an embodiment of the invention. Embodiments of the invention are not limited to the depicted example formats.

Message header 600 includes a peer-to-peer graphing message size data field 608, a message version data field 610 and a message type data field 612. The value of the message size data field 608 is a four byte number indicating the number of bytes in a peer-to-peer graphing message including the message header 600. The value of the message version data field 610 indicates the design version of a peer-to-peer graphing message including the message header 600. The message version value may, for example, include a major version and a minor version component. The major version component may, for example, indicate the design version of a set of peer-to-peer graphing messages. The minor version may, for example, indicate the design version of a particular type peer-to-peer graphing message including the message header 600. Other peer-to-peer graphing message versioning schemes are possible as will be appreciated by one of skill in the art.

The value of the message type data field 612 indicates the type of peer-to-peer graphing message body that will follow the message header 600. In an embodiment of the invention, each type of peer-to-peer graphing message has a unique message type value. If the message parse module 410 (of FIG. 4) receives a peer-to-peer graphing message with an unknown message type value, the message may be discarded, the message details may be logged and the node that sent the message may be treated as potentially hostile.

The value of the padding data field 614 is unimportant. The salient feature of the padding data field 614 and like data fields depicted in like figures is the size of the padding data field. Padding data fields of different sizes are utilized to align blocks of message data (i.e., one or more data fields) to various byte boundaries, for example, two byte (word), four byte (double word or DWORD), and like boundaries such that the size of the message header 600 is a multiple of a power of two. Padding data fields may increase message parsing, formatting and/or transmission efficiency and may provide for minor message and/or protocol design adjustments such as one-bit flags.

In an embodiment of the invention, each peer-to-peer graphing message is sent from one peer-to-peer graph node to another in one or more peer-to-peer graphing message frames. FIG. 7 depicts a peer-to-peer graphing message frame 700 in accordance with an embodiment of the invention. The frame 700 includes a two byte frame size 702 indicating the size of frame data 704. The value of the frame size may be limited, for example, to 16 kilobytes (kB). If a message to be sent is larger than the maximum frame size, in an embodiment of the invention, the message is broken into parts each smaller than the maximum frame size, for example, if the maximum frame size is 16 kB and a particular message is 21 kB in size, it may be sent in two frames, the first frame 16 kB in size, the second frame 5 kB in size. Sending messages in frames may increase message parsing, formatting and/or transmission efficiency, in particular when the underlying data transmission is secure and/or the transmitted data stream is encrypted. It may also enable the message receiver to allocate a limited and predictable amount of resources for each sender to which the receiver is connected.

In an embodiment of the invention, a first peer-to-peer graphing message sent in a connecting mode is an authentication information (Auth_Info) message. It may be desirable that each message and/or each message frame sent between nodes in a peer-to-peer graph is, for example, encrypted and/or cryptographically signed. Before two peer-to-peer nodes may engage in secure communications, at least some information is sent “in the clear,” for example, indicating the desire to engage in secure communications. In an embodiment of the invention, the authentication information message plays this role. In an embodiment of the invention, as a result of the authentication message, a sending peer and a receiving peer engage in further exchanges to secure the underlying data transport mechanism. Such exchanges are known in the art and need not be detailed further here. A possible result of such exchanges is that the authentication information provided by the authentication information message is determined to be inadequate so that, for example, the underlying data transport mechanism is not secured, and/or further messages from the sender are discarded and the sender logged as a potentially hostile node.

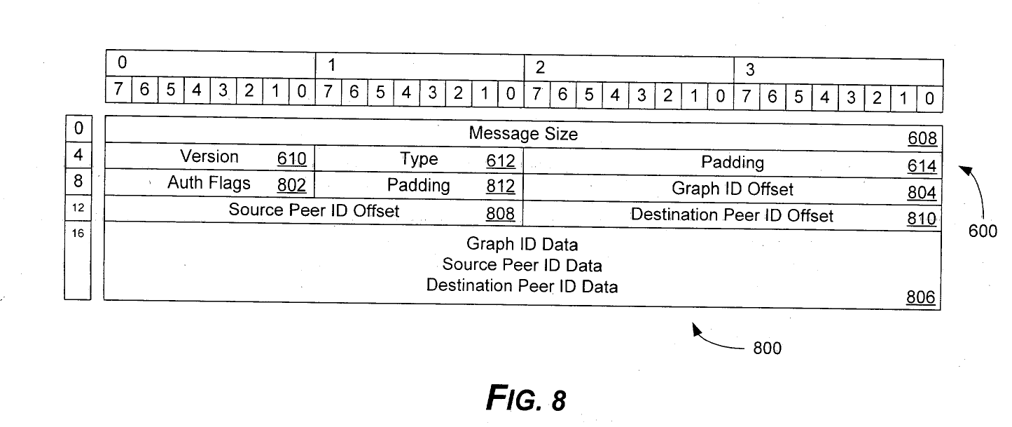

FIG. 8 depicts an example authentication information message 800 in accordance with an embodiment of the invention. The authentication information message 800, as does each example peer-to-peer graphing message described herein, first includes the message header 600 described with reference to FIG. 6. The authentication information message 800 further includes an authentication flags data field 802, a fixed size message offset data field 804 indicating the location of a variable size graph identifier in a variable size data message part 806, an offset 808 to a source peer identifier, and an offset 810 to a destination peer identifier.

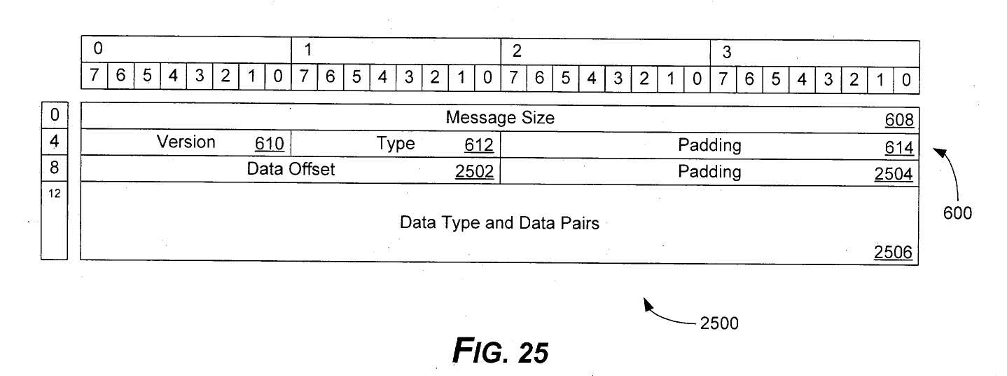

The one byte authentication flags data field 802 includes a graphing flag and a point-to-point (PT2PT) flag. The graphing flag indicates that the sender of the authentication information message 800 desires to establish a peer-to-peer communications connection over which it will send peer-to-peer graphing messages. The point-to-point flag indicates that the sender desires to establish a connection over which it will send point-to-point messages. Point-to-point messages are described in detail below with reference to FIG. 25. In an embodiment of the invention at least one of these two flags will be set. If only the graphing flag is set, then, once a connection is established, the sender may not be authorized to send point-to-point messages. If only the point-to-point flag is set, then the sender may be authorized only to send point-to-point messages. The authentication flags data field 802 is followed by one byte of padding 812 for data field alignment purposes.

The graph identifier offset 804 is set to the message offset of the graph ID in the variable size data message part 806, for example, a value of 16 indicates that the graph ID starts at the beginning of the variable size data message part 806. The graph ID identifies the graph that the sending peer desires to join. Each peer-to-peer graph may have its own authentication policy. The source peer identifier offset 808 is set to the location of the source peer identifier in the variable size data message part 806, for example if the source peer ID follows the graph ID and the graph ID is 180 bytes in length, then the source peer identifier offset 808 is set to 196. The source peer ID identifies the peer sending the authentication information message 800. The destination peer identifier offset 810 locates the destination peer ID in the variable size data message part 806. The destination peer ID identifies the peer that receives the authentication information message 800. In an embodiment of the invention, the destination peer ID may be set to ‘0’ to indicate that the sending peer is interested in establishing contact with any peer at the network protocol address where the authentication information message 800 is sent.

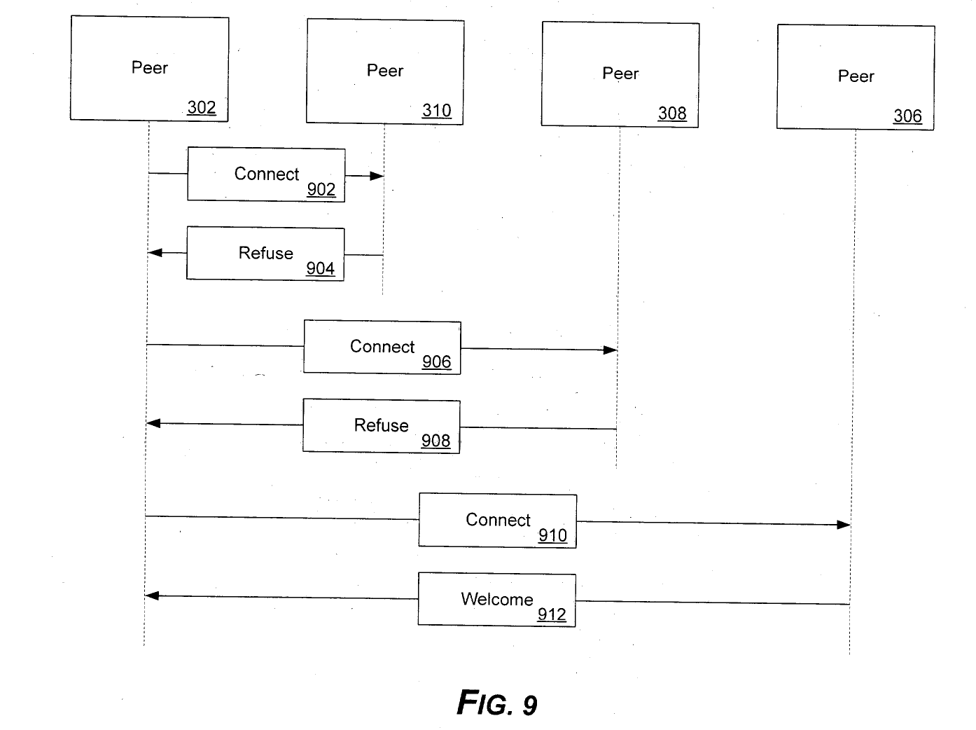

In an embodiment of the invention, a connection between two peers in a peer-to-peer graph may be established with a connecting mode protocol involving a peer connect message, a peer refuse message and a peer welcome message. The connect message initiates the protocol. The peer receiving the connect message responds with either the refuse message or the welcome message. The refuse message may include a list of alternate peers to try. FIG. 9 depicts an example connecting mode protocol in accordance with an embodiment of the invention.

With reference to FIG. 9, peer 302 (i.e., of FIG. 3) attempts to establish a connection with peer 310 by sending a first connect message 902. Peer 310 is unable or unwilling to accommodate peer 302, for example, the peer-to-peer graph node manager (e.g., the node manager 402 of FIG. 4) for peer 310 may be configured to limit the number of connections for the graph 300 to two and peer 310 already has two peer connections in the graph 300. The node manager 402 may also be configured to limit the number of connections totaled across each graph in which peer 310 participates. Peer 310 may have a low bandwidth high latency underlying data transport mechanism, e.g., a 28.8 kilobit/second modem.

Peer 310 replies with a first refuse message 904. The first refuse message 904 includes a list of the peer's 310 neighbors in the peer-to-peer graph 300, i.e., peer 308 and peer 312, for peer 302 to try as alternates. Peer 302 selects peer 308 to try next. Peer 302 sends a second connect message 906 to peer 308. Peer 308 is likewise unable to accommodate peer 302 and replies with a second refuse message 908. The second refuse message 908 includes a list of the peer's 308 neighbors, i.e., peer 306, peer 310 and peer 314. Peer 302 sends a third connect message 910 to peer 306. This time, peer 306 replies with a welcome message 912 and a connection between peer 302 and peer 306 is thus established.

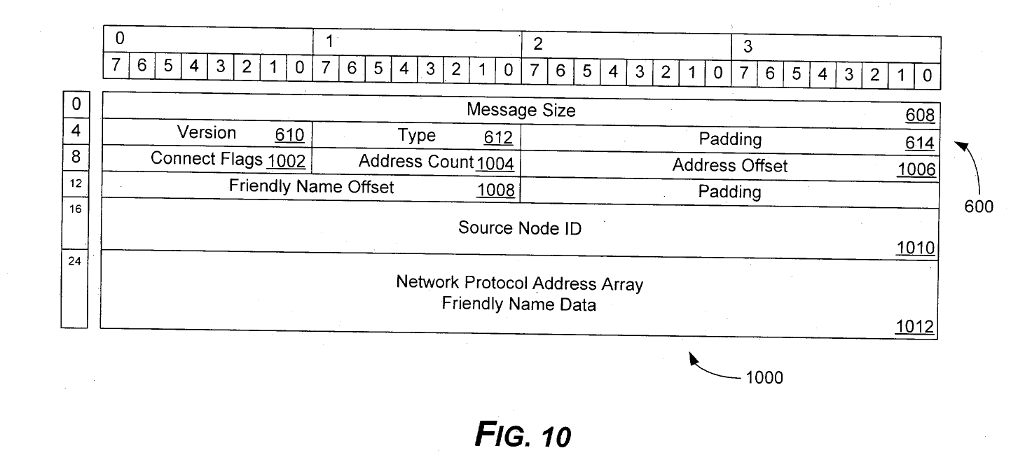

FIG. 10 depicts an exemplary peer-to-peer graphing connect message 1000 in accordance with an embodiment of the invention. The connect message 1000 includes a connect flags data field 1002, a network protocol address count data field 1004, an offset 1006 to a variable size network protocol address array, an offset 1008 to a variable size peer friendly name, and a source node ID 1010. A variable size data message part 1012 stores the message's 1000 variable size data.

The connect flags 1002 may include a neighbor list flag, a friendly name flag, a point-to-point flag, and an update flag. A set neighbor list flag is a request to the peer receiving the connect message 1000 to reply with a list of its neighbors in the peer-to-peer graph even if the reply is a welcome message. A set friendly name flag is a request to include a friendly name for the welcoming peer if the reply is a welcome message. A friendly name may, for example, be a human-readable text string such as “Richard Dodson.” The friendly name of a peer helps a person identify the peer when, for example, the peer ID is a cryptographic hash of the 1024-bit public key of the peer. A set point-to-point flag indicates that this connection is intended for point-to-point messages as opposed to, for example, flood messages. If the update flag is set then this connect message is not intended to result in the establishment of a new connection, but instead is providing updated information regarding an existing connection, for example, new or updated network protocol address information.

The variable size network protocol address array located by the offset 1006 includes a list of network protocol addresses associated with the peer sending the connect message 1000. For example, a list of IPv6 addresses associated with one or more data communication network interfaces of one or more computers executing the node manager utilized by the sending peer. The network protocol address count 1004 indicates the number of addresses in the array. Each element of the network protocol address array may include one or more data fields, for example, each element may include an element size or element type data field as well as network protocol address components. The following table sets forth an exemplary network protocol address array element for the IPv4 network protocol.

| Name | Type |
|---|---|
| Protocol | 2 byte enumeration with value IPv4 |
| Port | IPv4 2 byte port number |
| IPv4 Address | 4 byte IPv4 address |

The IPv4 address array element includes a protocol field specifying the type of protocol address specified in the array element (i.e., IPv4 in this example), a port field specifying the communications port associated with the IPv4 address, and an IPv4 address field specifying the 4 byte IPv4 address.

The following table set forth an exemplary network protocol address array element for the IPv6 network protocol.

| Name | Type |
|---|---|
| Protocol | 2 byte enumeration with value IPv6 |
| Port | IPv6 2 byte port number |
| IPv6 Address | 16 byte IPv6 address |

The IPv6 address array element includes a protocol field specifying the type of protocol address specified in the array element (i.e., IPv6 in this example), a port field specifying the communications port associated with the IPv6 address, and an IPv6 address field specifying the 16 byte IPv6 address.

The friendly name located by the offset 1008 is, for example, a variable size human-readable name of the peer sending the connect message. The source node ID 1010 is an 8 byte peer-to-peer graph node identifier for the graph node sending the connect message 1000.

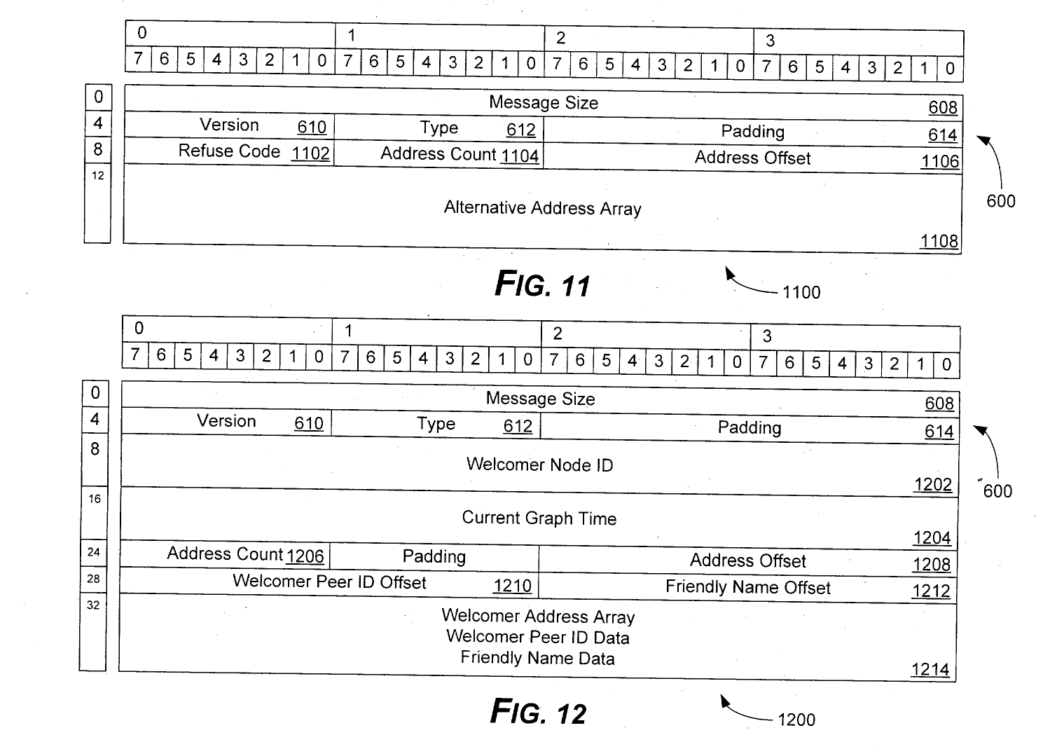

FIG. 11 depicts an exemplary peer-to-peer graphing refuse message 1100 in accordance with an embodiment of the invention. The refuse message 1100 includes an refuse code data field 1102, an alternative network protocol address count data field 1104, and an offset 1106 to a variable size alternative network protocol address array. A variable size data message part 1108 stores the message's 1100 variable size data.

Values of the refuse code data field 1102, corresponding to reasons for not welcoming the solicited connection, may include busy, already connected, duplicate connection and connection disallowed. The busy refuse code may result because the replying peer has reached its peer-to-peer graph connection limit. The already connected refuse code may result if the connect message is received over an existing peer-to-peer connection. The duplicate connection refuse code may result if a peer-to-peer connection between the requesting peer and the replying peer already exists, even if the connect message is not sent over that existing peer-to-peer connection. The connection disallowed refuse code may result if the requested connection would violate the replying peer's peer-to-peer connection policy, for example, the replying peer may disallow connections over which point-to-point messages are sent.

The alternative network protocol address array located by the offset 1106 may include a list of network protocol addresses for the requesting peer (e.g., peer 302 in FIG. 9) to try as alternatives to the peer (e.g., peer 310 or peer 308 of FIG. 9) replying with the refuse message. The address count data field 1104 indicates the number of addresses in the alternative network protocol address array. The number of addresses may be zero. The discussion regarding network protocol address array elements with reference to FIG. 10 applies to the alternative network protocol address array and like network protocol address arrays throughout this description.

FIG. 12 depicts an exemplary peer-to-peer graphing welcome message 1200 in accordance with an embodiment of the invention. The welcome message 1200 includes a welcomer node ID data field 1202, a current graph time data field 1204, a welcomer network protocol address count data field 1206, an offset 1208 to a variable size array of welcomer network protocol addresses, an offset 1210 to a variable size welcomer peer ID and an offset 1212 to a variable size welcomer friendly name. A variable size data message part 1214 stores the message's 1200 variable size data.

The welcomer node ID data field 1202 contains the peer-to-peer graph node ID of the replying peer's node ID for the graph (e.g., the graph 300 of FIG. 3). The current graph time data field 1204 contains the current graph time for the graph as determined by the replying peer, for example, formatted as a 64-bit value representing the number of 100-nanosecond intervals since Jan. 1, 1601 (graph time format). Other graph time formats are possible as will be appreciated by one of skill in the art. The welcomer network protocol address array located by the offset 1208 may include a list of the replying peer's-network protocol addresses, e.g., IPv6 addresses, as well as the replying peer's neighbor's network protocol addresses, e.g. , if requested by the connect message 1000 (of FIG. 10). The welcomeer network protocol address count data field 1206 contains the number of address in the array. The welcomer peer ID located by the offset 1210 is the peer ID of the replying peer. The friendly name located by the offset 1212 is the friendly name of the replying peer.

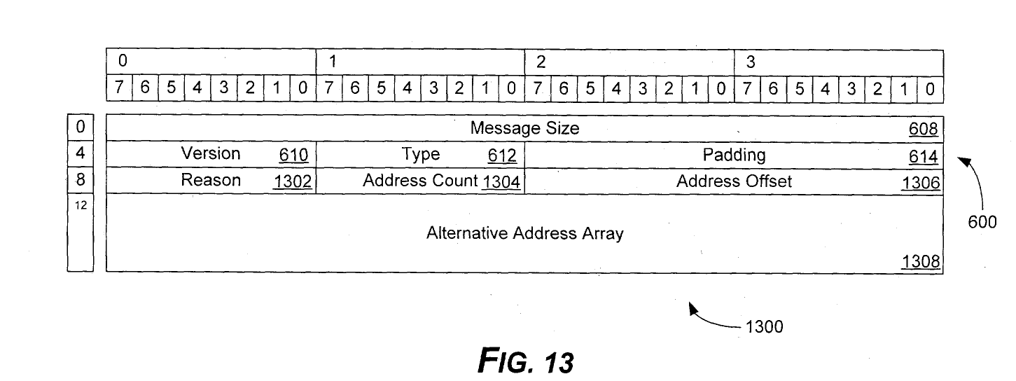

Just as the connect message 1000 may be utilized in establishing a connection between peers in the peer-to-peer graph, a disconnect message may be utilized to eliminate the connection. FIG. 13 depicts an exemplary peer-to-peer graphing disconnect message 1300 in accordance with an embodiment of the invention. The disconnect message 1300 includes a reason data field 1302, a network protocol address count data field 1304, and an offset 1306 to a variable size network protocol address array. A variable size data message part 1308 stores the message's 1300 variable size data.

The reason data field 1302 of the disconnect message 1300 may include values such as “leaving,” “least useful,” and “application decision.” When a peer in a peer-to-peer graph eliminates a connection to another peer, the peer requesting the disconnect may be leaving the graph entirely or eliminating the connection for some other reason. Any time a peer-to-peer connection is eliminated in a peer-to-peer graph, a graph partition is possible, that is, the graph may be split into two or more parts. For example, if the peer 308 of FIG. 3 eliminated its connection to peer 306, the graph 300 would be portioned into two parts: a first part including peer 302, peer 304 and peer 306, and a second part including peer 308, peer 310, peer 312 and peer 314. If a peer is leaving the peer-to-peer graph entirely, that is, eliminating each of its connections with other peers, at least temporarily, the leaving peer may set the reason data field 1302 value to “leaving” in the disconnect message 1300 to each of the peers with which it has a connection. For example, if peer 308 is leaving graph 300, then peer 308 may send a disconnect message 1300 with reason data field 1302 value “leaving” to each of peers 306, 310 and 314. The “leaving” reason may, for example, alert the peers receiving the disconnect message 1300 to the possibility of a graph partition.

A peer may eliminate a connection to another peer in the peer-to-peer graph even if it is not leaving the peer-to-peer graph entirely. For example, some of the peer's connections may be redundant. Peer-to-peer graphs may have a plurality of communication paths between peers. The same information may be communicated to a peer over different connections. One measure of the usefulness of a connection is the proportion of novel (i.e., not seen before, e.g., as determined by data record identifier comparison) information delivered to a peer over the connection. While, in general, redundancy is not undesirable in a peer-to-peer graph, connections with a low usefulness measure may, for example, be a priority for elimination when connection-related resources run low. If a peer is eliminating a connection because the connection has a low usefulness measure, the peer may set the reason data field 1302 value to “least useful” in the disconnect message 1300 sent to eliminate the connection. Receiving a disconnect message 1300 with the reason data field 1302 set to “least useful” may, for example, indicate to the receiving peer a lower graph partition probability as a result of the connection being eliminated.

A reason data field 1302 value of “application decision” may indicate that the decision to eliminate the connection was not an automatic decision made by the peer-to-peer graphing layer but instead a decision made in the application layer. For example, the application layer may have a policy with regard to the cost associated with a connection that results in connection elimination, or the peer may decide that the data transport mechanism underlying the connection is insufficiently secure.

The network protocol address array located by the offset 1306 may include a list of network protocol addresses of the peer-to-peer graph neighbors of the peer sending the disconnect message 1300. A peer receiving the disconnect message 1300 may, for example, seek to prevent partitioning of the peer-to-peer graph by establishing a connection to another peer before the connection on which the disconnect message 1300 was received is eliminated. For example, if peer 308 in graph 300 (of FIG. 3) sends a disconnect message 1300 to each of its neighbors (i.e., peers 306, 310 and 314) that includes the list of its neighbor's underlying network protocol addresses then each of its neighbors may attempt to prevent partitioning of the graph 300 by establishing a new connection. In this example scenario, successfully establishing a connection between peer 306 and either peer 310 or peer 314 prevents a partition of graph 300. The network protocol address count data field 1304 indicates the number of network protocol addresses in the array.

In an embodiment of the invention, once a connection has been established between two peers in the peer-to-peer graph, the newly connected peers progress to a synchronizing mode of communication. A goal of the synchronizing communications mode is to synchronize the database record set (e.g., a record set in the peer-to-peer graph database 404 of FIG. 4) maintained for the peer-to-peer graph by the node manager (e.g., the node manager 402) of each peer. In an embodiment of the invention, peer-to-peer graph record set synchronization is accomplished with a synchronizing mode protocol involving a solicit message, a flood message, an acknowledgement (Ack) message and a synchronize end (SynchEnd) message. There may be more than one type of solicit message, for example, a solicit new (SolicitNew) message for the situation of joining a particular graph for the first time, a solicit time (SolicitTime) message for requesting graph records created or modified after a specified time, and a solicit hash (SolicitHash) message to initiate an efficient record bucket hash based scheme for identifying and eliminating differences between graph record sets.

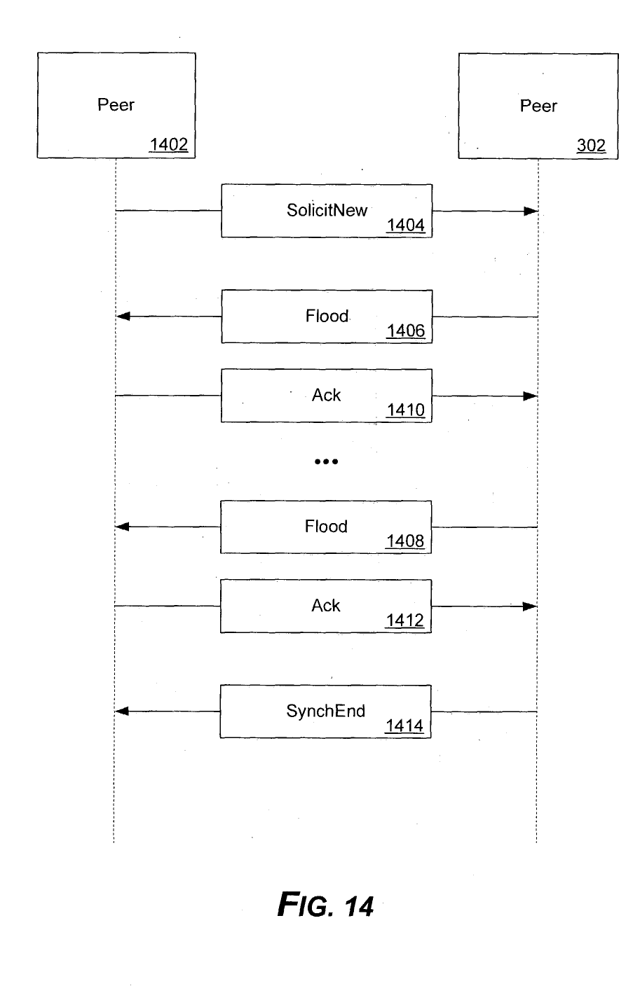

FIG. 14 depicts a synchronizing mode protocol incorporating the solicit new message in accordance with an embodiment of the invention. Peer 1402 has established a connection with peer 302 of peer-to-peer graph 300 (peer 1402 is not shown in FIG. 3). Peer 1402 now seeks to synchronize its peer-to-peer graph record set for graph 300 with the record set for graph 300 maintained by the node manager of peer 302. In this example scenario, peer 1402 has not participated in graph 300 before so that its record set for graph 300 is empty. Peer 1402 sends peer 302 a solicit new message 1404. In response, peer 302 sends peer 1402 its record set for graph 300 in one or more flood messages 1406, 1408. In response to each flood message 1406, 1408, peer 1402 sends an acknowledgement message 1410, 1412. Once peer 302 has sent each of the records in its record set for graph 300, peer 302 sends peer 1402 the synchronize end message 1414.

FIG. 15 depicts an exemplary peer-to-peer graphing solicit new message 1500 in accordance with an embodiment of the invention. The solicit new message 1500 includes a record type include count data field 1502, a record type exclude count data field 1504, and an offset 1506 to a variable size array of record types. A variable size data message part 1508 stores the message's 1500 variable size data.

The set of database records for the peer-to-peer graph may include one or more different types of record, for example, graph information, peer contact details, peer presence information, and cryptographic signatures. In an embodiment of the invention, each peer-to-peer graph record type is identified by a universal unique identifier (UUID). UUIDs are known in the art and need not be detailed here. The solicit new message 1500 may request one or more types of peer-to-peer graph record. The record type array located by the offset 1506 lists the record types to be included and/or excluded in response to the solicit new message 1500. The record types to be included in the response may be listed first. The record types to be excluded may be listed next. The record type include count data field 1502 indicates the number of record types in the array that are record types to include. The record type exclude count data field 1504 indicates the number of record types in the array that are to be excluded in the response.

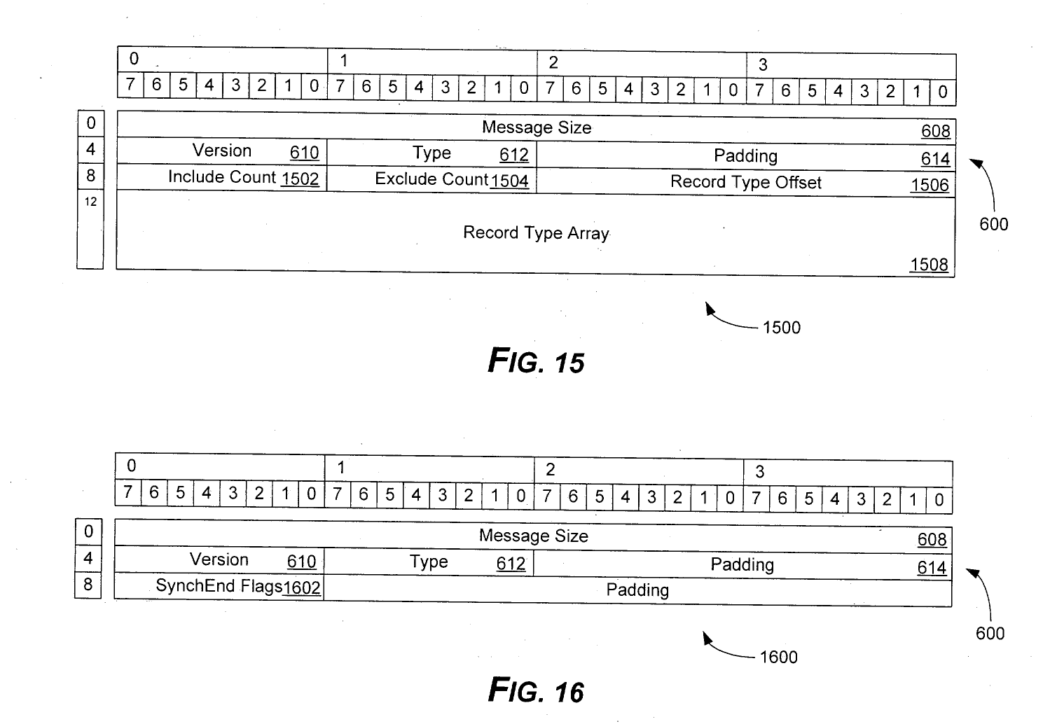

FIG. 16 depicts an exemplary peer-to-peer graphing synchronize end message 1600 in accordance with an embodiment of the invention. The synchronize end message 1600 includes a synchronize end flags data field 1602. Synchronize end flags may include a final flag indicating that the response to the solicit message (e.g., the solicit new message 1500) is complete. Exemplary peer-to-peer graphing flood and acknowledge messages are described in detail below in the context of a peer-to-peer graph flooding mode of communication.

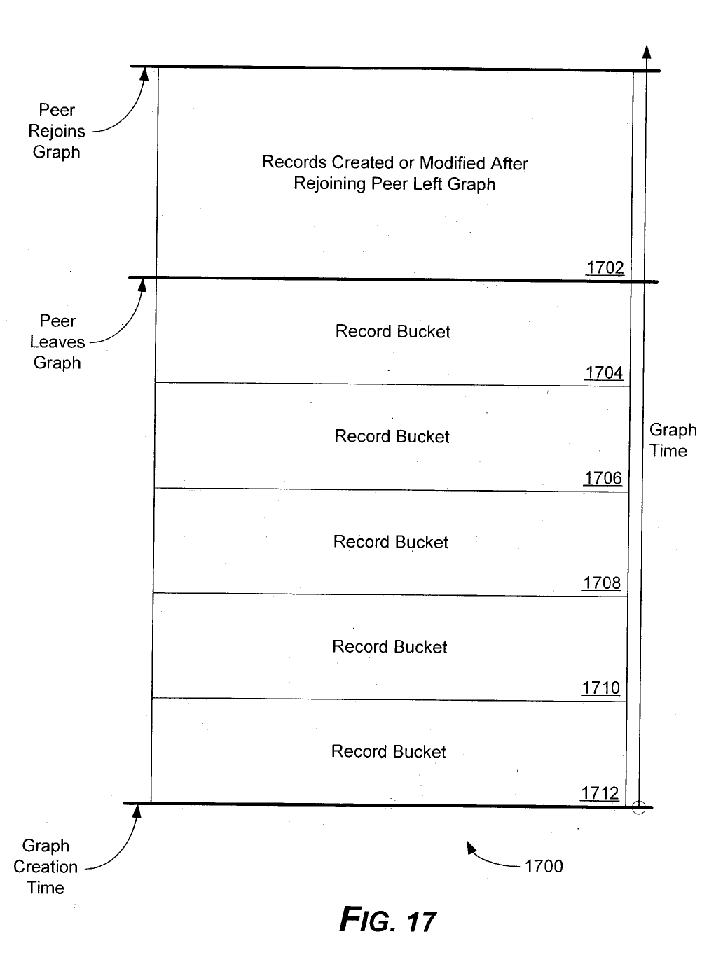

Before describing a synchronization mode protocol incorporating the solicit time and solicit hash messages, it will be instructive to describe the peer-to-peer graph record set in more detail. A peer may leave and rejoin a peer-to-peer graph. While the peer is absent from the graph, new records may be added to the graph record set and/or existing records modified. Each record in the graph record set may include a record identifier (e.g., a UUID), a record type version, a record type (e.g., a UUID), a record creation time (in graph time), a record creator identifier (e.g., a peer ID), a record last modification time (in graph time), and a record last modifier identifier (e.g., a peer ID) as well as various data fields. FIG. 17 schematically illustrates a peer-to-peer graph record set 1700 sorted in order of record last modification time (which is the same as record creation time if the record has not been modified) with most recently modified/created records towards the top. A subset 1702 of the record set 1700 may have records with modification/creation times during the interval that the peer was absent from the graph. The remaining records in the record set may be allocated to one or more record buckets 1704, 1706, 1708, 1710, 1712 of one or more records each.

In an embodiment of the invention, there is a need to synchronize graph records with modification/creation times during the interval (e.g., subset 1702) that the peer was absent from the graph. There is also a need to synchronize the remaining graph records, that is, it is possible for the remaining graph records to be desynchronized because, for example, of peer-local clock inaccuracies and/or finite new/changed record peer-to-peer propagation times. However, in an embodiment of the invention, it is likely that the majority of the remaining graph records are synchronized with the graph record set on the rejoining peer. The number of remaining graph records may be large enough so that record-by-record comparison of the entire record set would be inefficient. In an embodiment of the invention, the remaining record set is allocated into a plurality of record buckets (such as the record buckets 1704, 1706, 1708, 1710, 1712 of FIG. 17) and a cryptographic hash of each bucket is determined. Then corresponding record bucket hashes are determined for the graph record set of the rejoining peer and those record buckets with mismatching hashes are compared record-by-record.

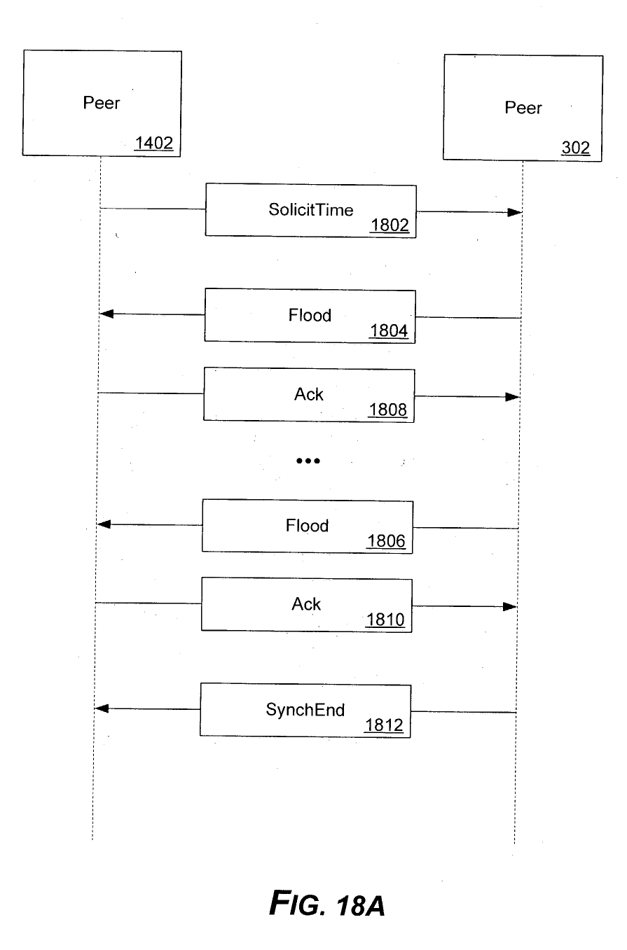

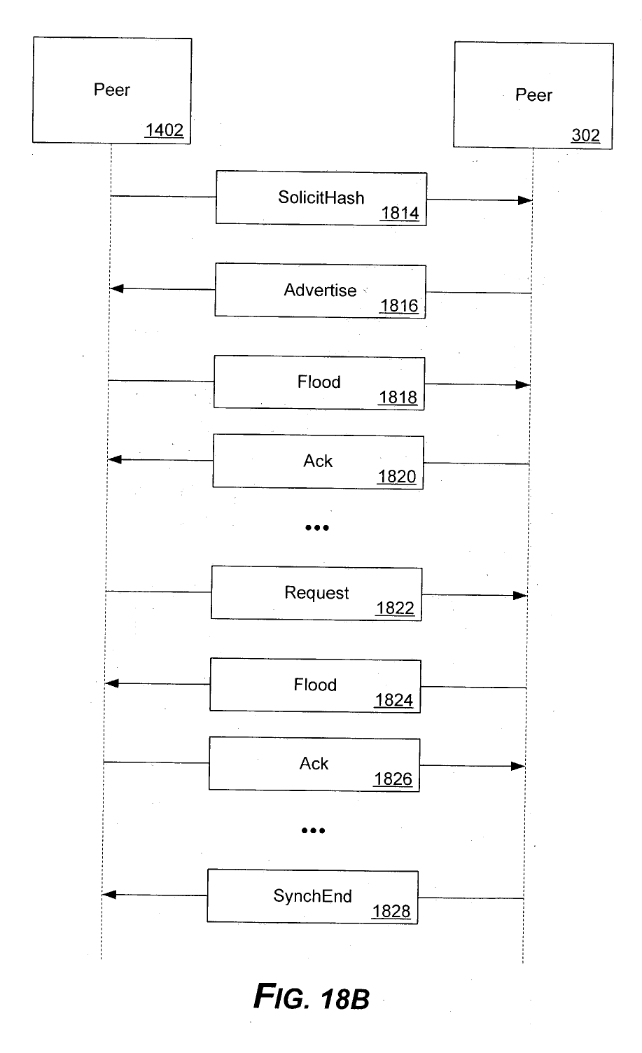

FIG. 18A and FIG. 18B depict a synchronizing mode protocol incorporating the solicit time message and the solicit hash message in accordance with an embodiment of the invention. In this example scenario, the peer 1402 has rejoined the peer-to-peer graph 300 (peer 1402 not shown in FIG. 3) after an absence by establishing a connection with peer 302. Peer 1402 now seeks to resynchronize its peer-to-peer graph record set for the graph 300 with the record set for the graph 300 maintained by peer 302. Peer 1402 sends a solicit time message 1802 to peer 302. The solicit time message 1802 includes the time (as measured in graph time) that the peer 1402 most recently left the graph 300. In response to the solicit time message 1802, peer 302 sends peer 1402 the records in its record set for the graph 300 with a modification/creation time after the time that the peer 1402 left the graph 300. As for the protocol described with reference to FIG. 14, the records are sent in one or more flood messages 1804, 1806, acknowledged by one or more acknowledge messages 1808, 1810, and the record transmission sequence completed with a synchronize end message 1812.

Next, the node manager for peer 1402 allocates the remaining records in its record set for graph 300 (i.e., the records not sent by peer 302) into one or more buckets and determines a cryptographic hash for each bucket. The hashes and associated bucket definitions are sent to peer 302 in a solicit hash message 1814. Peer 302 allocates its remaining record set for graph 300 into equivalent buckets, determines the equivalent cryptographic hash for each bucket, and returns the hashes, along with record abstracts, in an advertise message 1816. For each record bucket with a mismatching hash, peer 1402 performs a record-by-record comparison of the record IDs in the record abstracts with the record IDs in its record set. At this point, peer 1402 is able to determine the record IDs of any records that are not in synchronization with the record set of peer 302.

If there are no records that are not in synchronization then the synchronization phase is complete and the peer 1402 may progress to a flooding mode of communication with peer 302. If peer 302 is missing some records that peer 1402 has then peer 1402 sends the records to peer 302 in one or more flood messages (e.g., flood message 1818). Each flood message 1818 is acknowledged by an acknowledge message (e.g., acknowledge message 1820). If peer 1402 is missing some records that peer 302 has then peer 1402 sends peer 302 a request message 1822 requesting those records. The requested records are sent by peer 302 in one or more flood messages (e.g., flood message 1824), acknowledged by one or more acknowledge messages (e.g., acknowledge message 1826), and a synchronize end message 1828 completes the record transmission sequence and the synchronization phase. The record sets for graph 300 at each of the peers 1402, 302 are now synchronized.

FIG. 19 depicts an exemplary peer-to-peer graphing solicit time message 1900 in accordance with an embodiment of the invention. The solicit time message 1900 includes a record type include count data field 1902, a record type exclude count data field 1904, an offset 1906 to a variable size array of record types, and a most recent modification time data field 1908. A variable size data message part 1910 stores the message's 1900 variable size data.

The most recent modification time data field 1908 contains the time, in graph time, of the most recently modified/created record in the sending peer's graph record set before sending the solicit time message 1900, that is, the time of the last record in the sending peer's graph record set modified or created before the sending peer left the peer-to-peer graph. Similarly to the solicit new message 1500 (of FIG. 15), the record type array located by the offset 1906 includes a list of one or more peer-to-peer graph record types, record types to be included in the response to the solicit time message 1900 first, record types to be excluded next. The record type include count 1902 is the number of record types in the array to be included in the response. The record type exclude count 1904 is the number of record types in the array to be excluded.

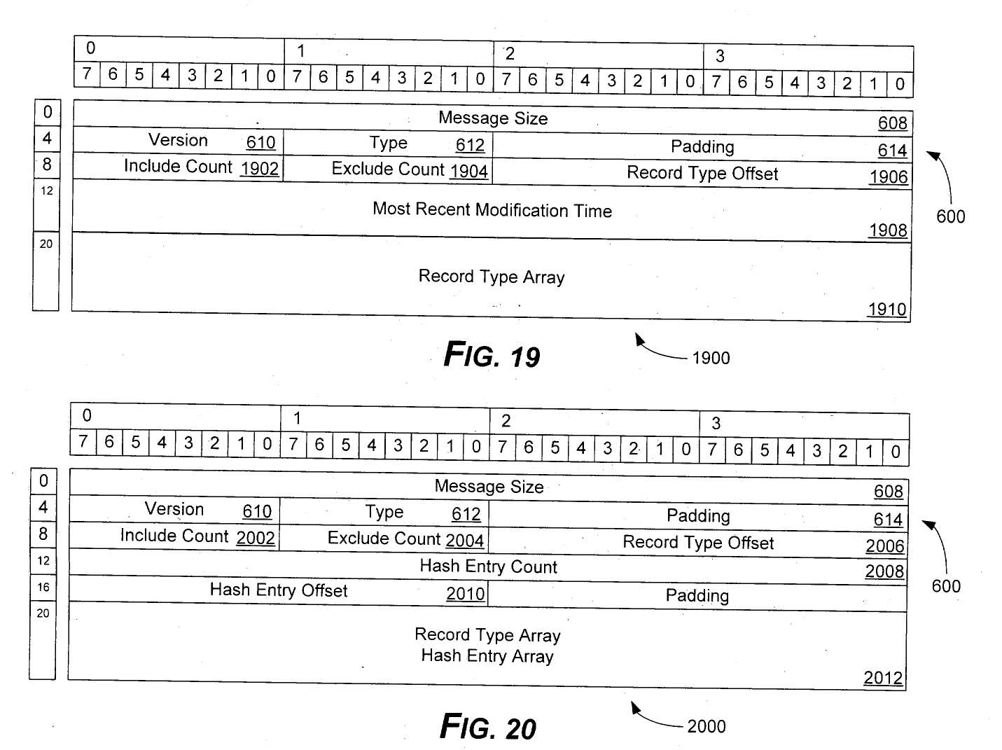

FIG. 20 depicts an exemplary peer-to-peer graphing solicit hash message 2000 in accordance with an embodiment of the invention. The solicit hash message 2000 includes a peer-to-peer graph record type include count data field 2002, a peer-to-peer graph record type exclude count data field 2004, an offset 2006 to a variable size peer-to-peer graph record type array, a peer-to-peer graph record bucket hash entry count data field 2008, and an offset 2010 to a variable size peer-to-peer graph record bucket hash entry array. A variable size data message part 2012 stores the message's 2000 variable size data.

The hash entry array located by the offset 2010 contains one or more hash entries, each hash entry including one or more record bucket boundaries and a cryptographic hash for the record bucket described by the one or more boundaries. The hash entry count data field 2008 indicates the number of entries in the hash entry array. The following table shows an example hash entry structure in accordance with an embodiment of the invention.

| Name | Type |
|---|---|
| Hash | 16 byte cryptographic hash |
| Modification Time | 64 bit graph time |
| Record ID | UUID |

The example hash entry structure describes graph record buckets with respect to a graph record set sorted in order of record modification/creation time. For clarity, the record bucket boundary description scheme employed by the example is described with reference to FIG. 17. Each record bucket 1704, 1706, 1708, 1710, 1712 has a top (a most recently modified/created record) and a bottom. The top of the first record bucket 1704 is determined by the time at which the peer sending the solicit hash message 2000 most recently left the peer-to-peer graph associated with the record set. The bottom of the first record bucket 1704 is determined by the number of records allocated to the bucket. Each bucket may be allocated an equal number of records (e.g., 10). Alternatively, for example, buckets with older records may be allocated more records. Other bucket allocation schemes are possible as will be apparent to one of skill in the art.

The hash entry array located by offset 2010 may have a hash entry structure for each record bucket. The top of the second record bucket 1706 may be determined by the bottom of the first record bucket 1704, and so on. The record ID element of the example hash entry structure is set to the identifier of the record at the bottom of a record bucket. The modification time element of the example hash entry structure is set to the last modification/creation time of the record identified by the record ID. The hash element of the example hash entry structure is set to the result of a cryptographic hash function of the one or more records in the record bucket with the top and bottom thus described. Cryptographic hash functions are known in the art and need not be detailed here. In an embodiment of the invention, only part of the record, for example, the record ID, contributes to the record bucket hash.

The solicit hash message 2000 also has a record type inclusion/exclusion mechanism (i.e., data fields 2002, 2004 and 2006) similar to the mechanism utilized by the solicit new 1500 (of FIG. 15) and solicit time 1900 (of FIG. 19) messages.

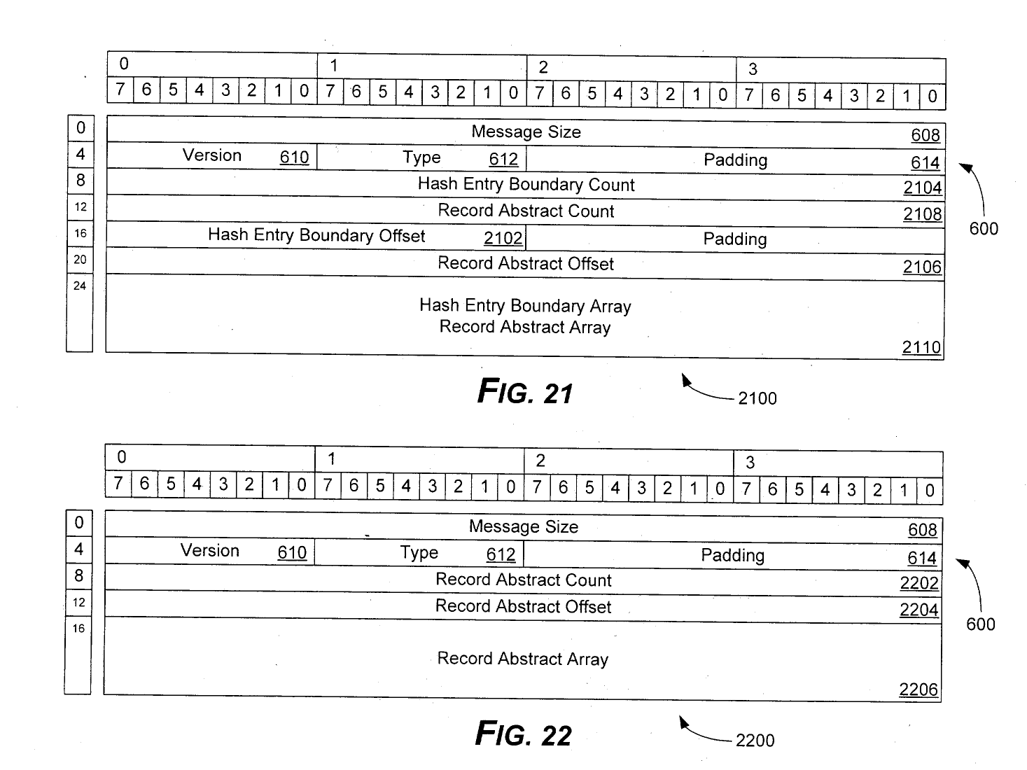

FIG. 21 depicts an exemplary peer-to-peer graphing advertise message 2100 in accordance with an embodiment of the invention. The advertise message 2100 includes an offset 2102 to a peer-to-peer graph record bucket hash entry boundary array, a hash entry boundary array count 2104, an offset 2106 to a peer-to-peer graph record abstract array, and a record abstract array count 2108. A variable size data message part 2110 stores the message's 2100 variable size data.

As described with reference to FIG. 18B, in an embodiment of the invention, the advertise message 2100 is sent in response to the solicit hash message 2000. The responding peer utilizes the data provided by the solicit hash message 2000 to allocate its graph record set into equivalent record buckets and determine an equivalent cryptographic hash function for those record buckets. For each record bucket with a mismatching hash, a hash entry boundary structure is added to the hash entry boundary array located by the offset 2102 and one or more record abstracts is added to the record abstract array located by the offset 2106. The hash entry boundary structure describes the boundaries of the mismatching record bucket and may include an indication of the number of records in the mismatching record bucket. The record abstracts include fields uniquely identifying each record in a mismatched record bucket.

Mismatching record buckets may not be consecutive, i.e., with respect to the record set as ordered by record last modification time, so that typically, the hash entry boundary structure includes both the upper record bucket boundary, e.g., identifying the most recently modified record in the bucket, and the lower record bucket boundary, e.g., identifying the least recently modified record in the bucket. The number of records in each mismatching record bucket may not be equal, so that, in order for the peer receiving the advertise message 2100 to be able to determine which record abstracts in the record abstract array located by offset 2106 correspond to which bucket, the record abstracts in the record abstract array may be ordered and further, may be ordered so as to correspond to the order of hash entry boundary structures in the hash entry boundary array located by offset 2102. For example, the first 10 elements of the record abstract array may be associated with the first element of the hash entry boundary array and the first element of the hash entry boundary array may include an abstract count with the value 10.

The following table shows an example hash entry boundary structure in accordance with an embodiment of the invention.

| Name | Type |
|---|---|
| Lower Record Modification Time | 64 bit graph time |
| Lower Record ID | UUID |
| Upper Record Modification Time | 64 bit graph time |
| Upper Record ID | UUID |
| Record Abstract Count | DWORD |
| | (i.e., 4 byte value) |

In this example, the lower record modification time and upper record modification time describe the boundaries of a mismatching record bucket, i.e., the least recent and most recent modification times, respectively, for the records at the boundaries of the mismatching record bucket. The lower and upper record IDs are set to the corresponding record IDs of the boundary records. The record abstract count is the number of records in the bucket described by the boundaries. In an embodiment of the invention the record abstract count indicates how many of the record abstracts in the record abstract array correspond to the bucket described by the boundaries.

The following table shows an example record abstract in accordance with an embodiment of the invention.

| Name | Type |
|---|---|
| Record ID | UUID |
| Record Type Version | DWORD (i.e., 4 byte value) |

The record ID uniquely identifies the record with respect to each peer-to-peer graph in which the peer participates. In this example record abstract, the record type version is also included, for example, to cover the case that the record identification scheme changes between record type versions.

FIG. 22 depicts an exemplary peer-to-peer graphing request message 2200 in accordance with an embodiment of the invention. The request message 2200 includes an offset 2202 to a record abstract array, and a record abstract count 2204. A variable size data message part 2206 stores the message's 2200 variable size data.

As described with reference to FIG. 18B, in an embodiment of the invention, the request message 2200 is sent in response to the advertise message 2100. The peer receiving the advertise message 2100 may utilize the contents of the advertise message 2100 to determine which, if any, peer-to-peer graph records that the receiving peer is missing from its record set for the graph in which the peer receiving and the peer sending the advertise message 2100 are participating. If the receiving peer determines that one or more records are missing, then the receiving peer may send the request message 2200 to request the missing records. The record abstract array located by offset 2202 includes the record abstract for each missing record. The record abstract count 2204 indicates the number of record abstracts in the record abstract array. In this example the structure of the record abstract is the same as described with reference to FIG. 21.

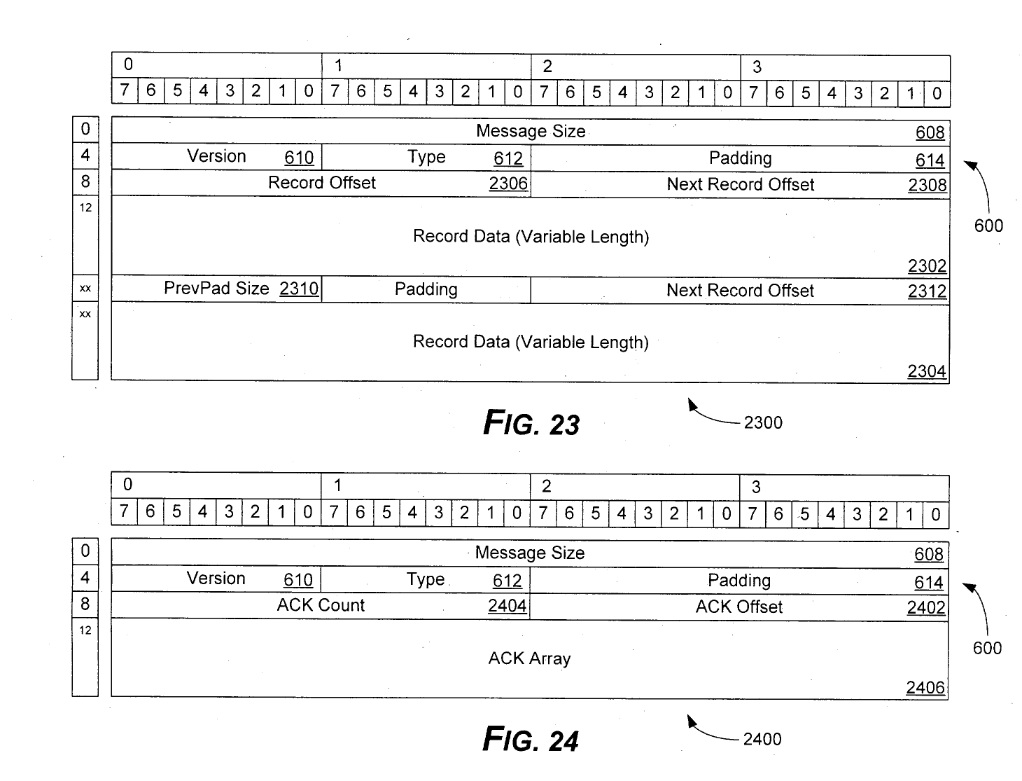

The flood message is utilized in both synchronizing and flooding modes of peer-to-peer communication to transfer peer-to-peer graph records between peers. FIG. 23 depicts an exemplary peer-to-peer graphing flood message 2300 in accordance with an embodiment of the invention. The flood message 2300 may include one or more variable size peer-to-peer graph records 2302, 2304. Each record 2302, 2304 has, for example, a four byte, header. The header of the first record 2302 includes an offset 2306 locating the first record 2302 in the flood message 2300 and a next record offset 2308 locating the start of the header of the next record (e.g., the record 2304). If the flood message 2300 includes only one record 2302, the next record offset 2308 is set to zero.

The header of records subsequent to the first (e.g., the record 2304) include a previous record padding size data field 2310 and a next record offset 2312. The value of the previous record padding size data field 2310 indicates the number of bytes padding appended to the previous record (e.g., the record 2302) in order for the previous record to terminate on a, for example, four, byte boundary. Like the next record offset 2308, the next record offset 2312 locates the start of the header of the next record and may be set to zero if the record 2304 is the last record included in the flood message 2300.

In an embodiment of the invention, an acknowledge message is sent in reply to each received flood message. FIG. 24 depicts an exemplary peer-to-peer graphing acknowledge message 2400 in accordance with an embodiment of the invention. The acknowledge message 2400 includes a variable size acknowledge array located by an offset 2402, and an acknowledge count 2404. A variable size data message part 2406 stores the message's 2400 variable size data.

The acknowledge array may include one or more acknowledgement structures. In an embodiment of the invention there is a corresponding acknowledgement structure for each record sent in the flood message that the acknowledge message 2400 is acknowledging. The following table shows an example acknowledgement structure in accordance with an embodiment of the invention.

| Name | Type |
|---|---|
| Record ID | UUID |
| Acknowledge Flags | DWORD (i.e., 4 byte value) |

In the example acknowledgement structure, the record ID identifies the record being acknowledged. The acknowledge flags associated with the record ID may include a useful flag. If the useful flag for the record identified by the record ID is set in the acknowledge message 2400 then, in an embodiment of the invention, the peer sending the acknowledge message 2400 had not previously received the record. If the useful flag is not set then, for example, the peer may have previously received the record identified by the record ID in a flood message other than the flood message being acknowledged. The useful flag may be utilized by a peer sending unsolicited flood messages in a flooding mode of peer-to-peer communications to determine the proportion of redundant information that the peer is sending to a neighbor in the peer-to-peer graph.

In a flooding mode of communication in accordance with an embodiment of the invention, flood messages received by a peer are flooded (sent) to each of the peers with which the receiving peer has a connection, that is, to each of the neighbors of the receiving peer in the peer-to-peer graph except, of course, the neighbor that originally sent the flood message to the receiving peer. When, in the flooding or synchronizing mode of peer-to-peer communication, flooding behavior is not desired, a point-to-point message may be utilized. FIG. 25 depicts an exemplary peer-to-peer graphing point-to-point message 2500 in accordance with an embodiment of the invention. The point-to-point message 2500 includes a variable size data array located by an offset 2502. The offset 2502 is padded with padding 2504 to a four byte boundary. A variable size data message part 2506 stores the message's 2500 variable size data. Each of the elements of the data array located by the offset 2502 may include a data type and a data payload. Alternatively, the a data size may be substituted for the data type.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-readable medium having thereon computer-executable instructions for performing a method comprising:
processing a first peer-to-peer graphing connect message, wherein the first peer-to-peer graphing connect message comprises:
a peer-to-peer graph node identifier; and
a first variable size network protocol address array; and
processing a peer-to-peer graphing refuse message in response to the first peer-to-peer graphing connect message, wherein the peer-to-peer graphing refuse message comprises:
a refuse code comprising an indication of why a peer-to-peer graphing welcome message was not sent in response to the first peer-to-peer graphing connect message; and
a second variable size network protocol address array comprising at least one network protocol address of an alternative destination for a second peer-to-peer graphing connect message.

2. The computer-readable medium of claim 1, wherein the peer-to-peer graph node identifier comprises a pseudo-randomly generated number.

3. The computer-readable medium of claim 1, wherein each element of each network protocol address array comprises:
a network protocol specifier; and
a network protocol address.

4. The computer-readable medium of claim 1, wherein processing the peer-to-peer graphing message comprises formatting the peer-to-peer graphing message.

5. The computer-readable medium of claim 1, wherein processing the peer-to-peer graphing message comprises disassembling the peer-to-peer graphing message into one or more peer-to-peer graphing message frames.

6. The computer-readable medium of claim 1, wherein processing the peer-to-peer graphing message comprises parsing the peer-to-peer graphing message.

7. The computer-readable medium of claim 1, wherein processing the peer-to-peer graphing message comprises assembling the peer-to-peer graphing message from one or more peer-to-peer graphing message frames.

8. The computer-readable medium of claim 1, wherein each peer-to-peer graphing message further comprises a peer-to-peer graphing message header, and wherein the peer-to-peer graphing message header comprises:
a peer-to-peer graphing message size;
a peer-to-peer graphing message version; and
a peer-to-peer graphing message type.

9. The computer-readable medium of claim 1, wherein the computer-executable instructions for performing the method further comprise processing a peer-to-peer graphing authentication information message for initiating the negotiation of a secure underlying data transport mechanism, wherein the peer-to-peer graphing authentication information message comprises:
a peer-to-peer graph identifier; and
a source peer identifier.

10. The computer-readable medium of claim 1, wherein the computer-executable instructions for performing the method further comprise processing a second peer-to-peer graphing connect message in response to the peer-to-peer graphing refuse message.

11. A computer-readable medium having thereon computer-executable instructions for performing a method comprising:
processing a first peer-to-peer graphing connect message, wherein the first peer-to-peer graphing connect message comprises:
a first peer-to-peer graph node identifier; and
a first variable size network protocol address array; and
processing a peer-to-peer graphing welcome message in response to the first peer-to-peer graphing connect message, wherein the peer-to-peer graphing welcome message comprises:
a second peer-to-peer graph node identifier; and
a current graph time.

12. The computer-readable medium of claim 11, wherein each peer-to-peer graph node identifier comprises a pseudo-randomly generated number.

13. The computer-readable medium of claim 11, wherein the computer-executable instructions for performing the method further comprise processing a peer-to-peer graphing authentication information message for initiating the negotiation of a secure underlying data transport mechanism, and wherein the peer-to-peer graphing authentication information message comprises:
a peer-to-peer graph identifier; and
a source peer identifier.

14. The computer-readable medium of claim 11, wherein the computer-executable instructions for performing the method further comprise processing a peer-to-peer graphing disconnect message subsequent to processing the peer-to-peer graphing welcome message, wherein the peer-to-peer graphing disconnect message comprises:
a disconnect reason corresponding to a peer-to-peer graph partition probability; and
a second variable size network protocol address array comprising at least one network protocol address of an alternative destination for a second peer-to-peer graphing connect message.

15. A computer-readable medium having thereon computer-executable instructions for performing a method comprising:
processing a peer-to-peer graphing solicit new message, wherein the peer-to-peer graphing solicit new message comprises:
a peer-to-peer graph record type include count;
a peer-to-peer graph record type exclude count; and
a variable size peer-to-peer graph record type array; and
processing a peer-to-peer graphing flood message in response to the peer-to-peer graphing solicit new message, wherein the peer-to-peer graphing flood message comprises:
at least one variable size peer-to-peer graph record; and
for each peer-to-peer graph record, a peer-to-peer graphing message offset locating the next peer-to-peer graph record.

16. The computer-readable medium of claim 15, wherein the computer-executable instructions for performing the method further comprise processing a peer-to-peer graphing welcome message resulting in a peer-to-peer graphing message communication connection over which the peer-to-peer graphing solicit new message is sent, and wherein the peer-to-peer graphing welcome message comprises:
a peer-to-peer graph node identifier; and
a current graph time.

17. The computer-readable medium of claim 15, wherein the computer-executable instructions for performing the method further comprise processing a peer-to-peer graphing acknowledge message in response to the peer-to-peer graphing flood message, wherein the peer-to-peer graphing acknowledge message comprises a variable size acknowledge array having an array element for each peer-to-peer graph record in the peer-to-peer graphing flood message.

18. The computer-readable medium of claim 15, wherein the computer-executable instructions for performing the method further comprise processing a peer-to-peer graphing synchronize end message in response to the peer-to-peer graphing solicit new message.

19. A computer-readable medium having thereon computer-executable instructions for performing a method comprising:
processing a peer-to-peer graphing solicit time message, wherein the peer-to-peer graphing solicit time message comprises:
a peer-to-peer graph record type include count;
a peer-to-peer graph record type exclude count;
a most recent modification time of a peer-to-peer graph record set; and
a variable size peer-to-peer graph record type array; and
processing a peer-to-peer graphing flood message in response to the peer-to-peer graphing solicit time message, wherein the peer-to-peer graphing flood message comprises:
at least one variable size peer-to-peer graph record; and
for each peer-to-peer graph record, a peer-to-peer graphing message offset locating the next peer-to-peer graph record.

20. The computer-readable medium of claim 19, wherein the computer-executable instructions for performing the method further comprise processing a peer-to-peer graphing welcome message resulting in a peer-to-peer graphing message communication connection over which the peer-to-peer graphing solicit time message is sent, and wherein the peer-to-peer graphing welcome message comprises:
a peer-to-peer graph node identifier; and
a current graph time.

21. The computer-readable medium of claim 19, wherein the computer-executable instructions for performing the method further comprise processing a peer-to-peer graphing acknowledge message in response to the peer-to-peer graphing flood message, and wherein the peer-to-peer graphing acknowledge message comprises a variable size acknowledge array having an array element for each peer-to-peer graph record in the peer-to-peer graphing flood message.

22. The computer-readable medium of claim 19, wherein the computer-executable instructions for performing the method further comprise processing a peer-to-peer graphing synchronize end message in response to the peer-to-peer graphing solicit time message.

23. The computer-readable medium of claim 19, wherein the computer-executable instructions for performing the method further comprise processing a peer-to-peer graphing solicit hash message, and wherein the peer-to-peer graphing solicit hash message comprises:
a peer-to-peer graph record type include count;
a peer-to-peer graph record type exclude count;
a variable size peer-to-peer graph record type array; and
a variable size peer-to-peer graph record bucket hash entry array.

24. A computer-readable medium having thereon computer-executable instructions for performing a method comprising:
processing a peer-to-peer graphing solicit hash message, wherein the peer-to-peer graphing solicit hash message comprises:
a peer-to-peer graph record type include count;
a peer-to-peer graph record type exclude count;
a variable size peer-to-peer graph record type array; and
a variable size peer-to-peer graph record bucket hash entry array; and
processing a peer-to-peer graphing advertise message in response to the peer-to-peer graphing solicit hash message, wherein the peer-to-peer graphing advertise message comprises:
a variable size peer-to-peer graph record bucket hash entry boundary array; and
a first variable size peer-to-peer graph record abstract array.

25. The computer-readable medium of claim 24, wherein the computer-executable instructions for performing the method further comprise processing a peer-to-peer graphing solicit time message, and wherein the peer-to-peer graphing solicit time message comprises:
a peer-to-peer graph record type include count;
a peer-to-peer graph record type exclude count;
a most recent modification time of a peer-to-peer graph record set; and
a variable size peer-to-peer graph record type array.

26. The computer-readable medium of claim 24, wherein the computer-executable instructions for performing the method further comprise processing a peer-to-peer graphing request message in response to the peer-to-peer graphing advertise message, and wherein the peer-to-peer graphing request message comprises a second variable size peer-to-peer graph record abstract array.

27. A computer-readable medium having thereon computer-executable instructions for performing a method comprising:
processing a peer-to-peer graphing flood message, wherein the peer-to-peer graphing flood message comprises:
at least one variable size peer-to-peer graph record; and
for each peer-to-peer graph record, a peer-to-peer graphing message offset locating the next peer-to-peer graph record; and
processing a peer-to-peer graphing acknowledge message in response to the peer-to-peer graphing flood message, wherein the peer-to-peer graphing acknowledge message comprises a variable size acknowledge array having an array element for each peer-to-peer graph record in the peer-to-peer graphing flood message.

28. The computer-readable medium of claim 27, wherein the computer-executable instructions for performing the method further comprise processing a peer-to-peer graphing welcome message resulting in a peer-to-peer graphing message communication connection over which the peer-to-peer graphing flood message is sent, and wherein the peer-to-peer graphing welcome message comprises:
a peer-to-peer graph node identifier; and
a current graph time.

29. The computer-readable medium of claim 28, wherein the computer-executable instructions for performing the method further comprise processing a peer-to-peer graphing disconnect message subsequent to processing the peer-to-peer graphing welcome message, wherein the peer-to-peer graphing disconnect message comprises:
a disconnect reason corresponding to a peer-to-peer graph partition probability; and
a variable size network protocol address array comprising at least one network protocol address of an alternative destination for a peer-to-peer graphing connect message.

30. A computer-readable medium having stored thereon a peer-to-peer graphing message comprising a peer-to-peer graphing message header, the peer-to-peer graphing message header comprising:
a peer-to-peer graphing message size data field;
a peer-to-peer graphing message version data field;
a peer-to-peer graphing message type data field; and
padding such that the size in bytes of the peer-to-peer graphing message header is a multiple of a power of two.

31. The computer-readable medium of claim 30, wherein:
the peer-to-peer graphing message size data field occupies 4 bytes;
the peer-to-peer graphing message version data field occupies 1 byte;
the peer-to-peer graphing message type data field occupies 1 byte; and
the padding occupies 2 bytes.

32. The computer-readable medium of claim 30, wherein the data fields of the peer-to-peer graphing message are arranged in the peer-to-peer graphing message in the order that they are listed in the claim.

33. The computer-readable medium of claim 30, wherein the peer-to-peer graphing message further comprises:
a peer-to-peer graph authentication flags data field;
a first peer-to-peer graphing message offset to a peer-to-peer graph identifier;
a second peer-to-peer graphing message offset to a source peer identifier;
a third peer-to-peer graphing message offset to a destination peer identifier;
the peer-to-peer graph identifier;
the source peer identifier; and
the destination peer identifier.

34. The computer-readable medium of claim 33, wherein:
the peer-to-peer graph authentication flags data field occupies 1 byte; and
each peer-to-peer graphing message offset occupies 2 bytes.

35. The computer-readable medium of claim 30, wherein the peer-to-peer graphing message further comprises:
a peer-to-peer graph connect flags data field;
a network protocol address count data field;
a first peer-to-peer graphing message offset to a network protocol address array;
a second peer-to-peer graphing message offset to a friendly peer name;
a peer-to-peer graph node identifier;
the network protocol address array; and
the friendly peer name.

36. The computer-readable medium of claim 30, wherein the peer-to-peer graphing message further comprises:
a peer-to-peer graph connection refuse code data field;
a network protocol address count data field;
a peer-to-peer graphing message offset to a network protocol address array; and
the network protocol address array.

37. The computer-readable medium of claim 30, wherein the peer-to-peer graphing message further comprises:
a peer-to-peer graph node identifier;
a peer-to-peer graph time data field;
a network protocol address count data field;
a first peer-to-peer graphing message offset to a network protocol address array;
a second peer-to-peer graphing message offset to a peer identifier;
a third peer-to-peer graphing message offset to a friendly peer name;
the network protocol address array;
the peer identifier; and
the friendly peer name.

38. The computer-readable medium of claim 30, wherein the peer-to-peer graphing message further comprises:
a peer-to-peer graph disconnect reason data field;
a network protocol address count data field;
a peer-to-peer graphing message offset to a network protocol address array; and
the network protocol address array.

39. The computer-readable medium of claim 30, wherein the peer-to-peer graphing message further comprises:
a peer-to-peer graph record type include count data field;
a peer-to-peer graph record type exclude count data field;
a peer-to-peer graphing message offset to a peer-to-peer graph record type array; and
the peer-to-peer graph record type array.

40. The computer-readable medium of claim 30, wherein the peer-to-peer graphing message further comprises a peer-to-peer graph record set synchronize end flags data field.

41. The computer-readable medium of claim 30, wherein the peer-to-peer graphing message further comprises:
a peer-to-peer graph record type include count data field;
a peer-to-peer graph record type exclude count data field;
a peer-to-peer graphing message offset to a peer-to-peer graph record type array;
a peer-to-peer graph record set most recent modification time data field; and
the peer-to-peer graph record type array.

42. The computer-readable medium of claim 30, wherein the peer-to-peer graphing message further comprises:
a peer-to-peer graph record type include count data field;
a peer-to-peer graph record type exclude count data field;
a first peer-to-peer graphing message offset to a peer-to-peer graph record type array;
a peer-to-peer graph record bucket hash entry count data field;
a second peer-to-peer graphing message offset to a peer-to-peer graph record bucket hash entry array;
the peer-to-peer graph record type array; and
the peer-to-peer graph record bucket hash entry array.

43. The computer-readable medium of claim 30, wherein the peer-to-peer graphing message further comprises:
a peer-to-peer graph record bucket hash entry boundary count data field;
a peer-to-peer graph record abstract count data field;
a first peer-to-peer graphing message offset to a peer-to-peer graph record bucket hash entry boundary array;
a second peer-to-peer graphing message offset to a peer-to-peer graph record abstract array;
the peer-to-peer graph record bucket hash entry boundary array; and
the peer-to-peer graph record abstract array.

44. The computer-readable medium of claim 30, wherein the peer-to-peer graphing message further comprises:
a peer-to-peer graph record abstract count data field;
a peer-to-peer graphing message offset to a peer-to-peer graph record abstract array; and
the peer-to-peer graph record abstract array.

45. The computer-readable medium of claim 30, wherein:
the peer-to-peer graphing message further comprises one or more peer-to-peer graph records;
each peer-to-peer graph record in the peer-to-peer graphing message has a peer-to-peer graphing flood message record header;
the peer-to-peer graphing flood message record header for the first of the one or more peer-to-peer graph records comprises:
a first peer-to-peer graphing message offset to the first peer-to-peer graph record; and
a second peer-to-peer graphing message offset to the next peer-to-peer graphing flood message record header; and
the peer-to-peer graphing flood message record header for peer-to-peer graph records subsequent to the first of the one or more peer-to-peer graph records comprises:
a previous peer-to-peer graph record padding size data field; and
another peer-to-peer graphing message offset to the next peer-to-peer graphing flood message record header

46. The computer-readable medium of claim 30, wherein the peer-to-peer graphing message further comprises:
a peer-to-peer graph record acknowledge count data field;
a peer-to-peer graphing message offset to a peer-to-peer graph record acknowledge array; and
the peer-to-peer graph record acknowledge array.

47. The computer-readable medium of claim 30, wherein the peer-to-peer graphing message further comprises:
a peer-to-peer graphing message offset to a peer-to-peer graphing point-to-point message data array; and
the peer-to-peer graphing point-to-point message data array.
